(19) United States
(12) Patent Application Publication
(10) Pub. No.: US 2002/0068545 A1
(43) Pub. Date: Jun. 6, 2002

(54) Method and apparatus for coordinating charging for services provided in a multimedia session

(76) Inventors: Johnson Oyama, Solna (SE); Ina B. Widegren, Stockholm (SE); Johan E.G. Lundstrom, Pargas (FI); Patrik Olsson, Malmo Karlskrona (SE)

Correspondence Address: NIXON & VANDERHYE P.C., 8th Floor, 1100 North Glebe Road, Arlington, VA, 22201, US

(21) Appl. No.: 09/985,633

(22) Filed: Nov. 5, 2001

Related U.S. Application Data
(60) Provisional application No. 60/275,354, filed on Mar. 13, 2001.
(60) Provisional application No. 60/273,678, filed on Mar. 6, 2001.
(60) Provisional application No. 60/269,573, filed on Feb. 16, 2001.
(60) Provisional application No. 60/269,789, filed on Feb. 16, 2001.
(60) Provisional application No. 60/269,572, filed on Feb. 16, 2001.
(60) Provisional application No. 60/267,737, filed on Feb. 9, 2001.
(60) Provisional application No. 60/260,766, filed on Jan. 10, 2001.
(60) Provisional application No. 60/260,765, filed on Jan. 10, 2001.
(60) Provisional application No. 60/246,501, filed on Nov. 6, 2000.
(60) Provisional application No. 60/248,110, filed on Nov. 13, 2000.
(60) Provisional application No. 60/324,523, filed on Sep. 26, 2001.
(60) Provisional application No. 60/330,501, filed on Oct. 23, 2001.

(30) Foreign Application Priority Data
Jun. 22, 2001 (GB) 0115340.2

(51) Int. Cl. H04M 11/00

(52) U.S. Cl. 455/406

(57) ABSTRACT

The present invention provides a mechanism for coordinating charging for a multimedia session between a mobile terminal and a remote host on both an application/session level and on an IP/access bearer level. The multimedia session is established over a radio access network via a packet-switched access network coupled to a multimedia system. The multimedia system has one or more multimedia servers for providing multimedia services for multimedia sessions. A token associated with the multimedia session is generated and used to correlate session charges for operations performed in the packet-switched access network and for operations performed in the multimedia system.

### CROSS-REFERENCE TO RELATED APPLICATIONS

This application is related to commonly-assigned U.S. patent application Ser. No. 09/768,956, entitled “RSVP Handling in 3G Networks,” filed on Jan. 24, 2001; U.S. patent application Ser. No. 09/861,817, entitled “Application Influenced Policy,” filed on May 21, 2001, U.S. patent application Ser. No. ______, entitled “Method and Apparatus for Coordinating Quality of Service Requirements for Media Flows in a Multimedia Session With Bearer Resources,” filed on Nov. 5, 2001; and U.S. patent application Ser. No. ______, entitled “Media Binding to Coordinate Quality of Service Requirements for Media Flows in a Multimedia Session With IP Bearer Resources,” filed on Nov. 5, 2001, the disclosures of which are incorporated herein by reference.

### REFERENCE TO PRIORITY APPLICATIONS

This application claims priority from and incorporates by reference the following commonly-assigned provisional patent applications: 60/275,354 entitled “Enhancement of Authorization Token for RSVP Interworking,” filed Mar. 13, 2001; 60/273,678 entitled “SDP Support for QoS Based SIP Sessions,” filed Mar. 6, 2001; 60/269,573 entitled “QoS Characteristics for a UMTS Bearer Appropriate for IP Signaling,” filed Feb. 16, 2001; 60/269,789 entitled “Architecture for Packet Data Protocol Context Suitable for Signaling,” filed Feb. 16, 2001; 60/269,572 entitled “Binding a Signaling Bearer for Use With an IP Multimedia Subsystem,” filed Feb. 16, 2001; 60/267,737 entitled “Authorization Token in PDP Context Activation/Modification in Bearer Establishment for SIP Call Setup (Qos),” filed Feb. 9, 2001; 60/260,766 entitled “QoS Pre-Condition Met,” filed Jan. 10, 2001; 60/260,765 entitled “IP Specific Elements in PDP Context Activation/Modification,” filed Jan. 10, 2001; 60/246,501 entitled “Principle of User Choice,” filed Nov. 6, 2000; 60/248,110 entitled “Triggering RSVP Host,” filed Nov. 13, 2000; 60/324,523, entitled “Use of GPRS APN in IMS/IPv6 Context,” filed on Sep. 26, 2001; 60/330,501, entitled “Method an Apparatus for Coordinating Charging for Services Provided in a Multimedia Session,” filed Oct. 23, 2001; and a Great Britain provisionally filed application GB prov 0115340.2, entitled “Real Time GPRS Charging for IP Multimedia,” filed on Jun. 22, 2001.

### FIELD OF THE INVENTION

The present invention generally relates to Internet Protocol (IP) networks, and more specifically, to coordinating charging for various services involved in providing multimedia sessions.

### BACKGROUND

IP networks were originally designed to carry “best effort” traffic where the network makes a “best attempt” to deliver a user packet, but does not guarantee that a user packet will arrive at the destination. Because of the market success of IP networks, there is a clear requirement for mechanisms that allow IP networks to support various types of applications. Some of these applications have Quality of Service (QoS) requirements other than “best efforts” service. Examples of such applications include various real time applications (IP Telephony, video conferencing), streaming services (audio or video), or high quality data services (browsing with bounded download delays). Recognizing these QoS requirements, the Internet Engineering Task Force (IETF), which is the main standards body for IP networking, standardized a set of protocols and mechanisms that enable IP network operators to build QoS-enabled IP networks.

FIG. 1 depicts a simplified high-level model of an IP network which may be useful in explaining QoS provisioning. As can be appreciated, the model includes two users, but could easily be expanded to include more users without changing the basic functionality of the network. In FIG. 1, User-A 101 may communicate with User-B 102 or with an application server 103. For example, in the case of an IP telephony session, User-A 101 may communicate with User-B 102. Similarly, in the case of streaming services, User-A 101 may communicate with the application server 103, which may be configured as a video server. In either case, User-A 101 accesses an IP backbone network 104 through a local access network 105, such as the PSTN (dial-in access), a Global System for Mobile Communications (GSM), or a Universal Mobile Telecommunications System (UMTS) network. User-B 102 is similarly connected to the IP network 104 through a local access network 106. It will be appreciated that User-A and User-B need not use the same type of access network. The IP network 104 may consist of a number of IP routers and interconnecting links that together provide connectivity between the IP network's ingress and egress points and thereby make two party communication possible. As far as the users are concerned, the perceived QoS depends on the mechanisms both in the access networks 105, 106 and on the IP backbone network 104. Of particular interest to this invention is the specific case where at least one of the access networks is a UMTS or GSM/GPRS network.

When users access IP based services, they typically use a device that runs an application program that provides the interface for the user to access the particular service. For instance, in FIG. 1, User-A may use a laptop running a conferencing application program to attend an IP network based meeting, where participants of the meeting collaborate using various programs. Such programs are well known in the art.

Various user applications may access network services through an application programming interface (API). An API provides application programmers with a uniform interface to access underlying system resources. For instance, an API may be used to configure a network resource manager to require that a particular IP packet originating from a given application receive a certain treatment from the network, such as a particular QoS. For example, if the IP network is a Differentiated Services IP network, then an application program may request that all of its IP packets receive the “Expedited Forwarding” treatment.

The User (and the API in the user's equipment) may not be aware of the different technologies that various access networks and IP backbone networks employ in order to provide QoS end-to-end, i.e., from User-A all the way to remote User-B. For instance, the user application program may use an RSVP/IntServ based API, and the end-to-end embodiment in which he is involved may include a UMTS access network and a non-RSVP enabled IP network. In such cases, some “interworking” mechanisms between such different technologies and protocols are needed to make sure that the QoS is provided end-to-end.

Integrated Services (IntServ) provides a set of well-defined services which enables an application to choose among multiple, controlled levels of delivery service for their data packets. To support this capability, two things are required. First, individual network elements, such as subnets and IP routers, along the path followed by an application's data packets must support mechanisms to control the quality of service delivered to those packets. Second, a way to communicate the application's requirements to network elements along the path and to convey QoS management information between network elements and the application must be provided.

IntServ defines a number of services such as Controlled-Load (defined in IETF RFC 2211) and Guaranteed (defined in IETF RFC 2212). The service definition defines the required characteristics of the network equipment in order to deliver the service. The individual network elements (subnets and IP routers) that support the service must comply with the definitions defined for the service.

The service definition also defines the information that must be provided across the network in order to establish the service. This function may be provided in a number of ways, but it is frequently implemented by the resource reservation setup protocol (RSVP) (defined in IETF RFC 2205). RSVP (Resource reSerVation Protocol) is an IP-level resource reservation setup protocol designed for an IntServ-enabled Internet (defined in IETF RFC 1633, 2205, and 2210). The RSVP protocol is used by a host (e.g., User A's computer) to request specific service from the network for particular application data streams or flows. RSVP is also used by routers to deliver quality-of-service requests to all nodes along the path(s) of the flows and to establish and maintain the state(s) to provide the requested service. RSVP requests generally result in resources being reserved in each node along the data path.

FIG. 2 shows an End-to-End Integrated Service between the hosts. The service is provided using routers and hosts that support the service definition defined for the required service and through signaling of the relevant information between the nodes. Since RSVP is a protocol that is primarily designed to be end-to-end, extra functionality is required in a situation where the RSVP sender would like to use it for resource reservation only in some portion of the end-to-end path. This situation may arise if RSVP is used in an access network and over-provisioning is used in the backbone network. In such situations, an RSVP (Receiver) Proxy is useful.

A Proxy is a network device, such as a router or a switch, that performs one or more functions on behalf of another device. An RSVP Proxy originates the RSVP RESV message in response to an incoming PATH message on behalf of the receiver(s) identified by the PATH message. (RESV and PATH are well known messages used in RSVP.) In other words, the RSVP (Receiver) Proxy acts on behalf of the remote host and thereby facilitates resource reservation between the originating host and the RSVP Proxy without the host needing to be involved in RSVP signaling. This is shown in FIG. 3. The RSVP Proxy may use knowledge of network conditions between the RSVP Proxy and the non-RSVP host.

Differentiated Services (DiffServ) enhancements to the Internet protocol are intended to enable scalable service discrimination in the Internet without the need for per-flow state and signaling at every hop. A variety of services may be built from a small, well-defined set of building blocks which are deployed in network nodes. The services may be either end-to-end or intra-domain; they include both those that can satisfy quantitative performance requirements (e.g., peak bandwidth) and those based on relative performance (e.g., “class” differentiation).

Services may be constructed by a combination of setting bits in an IP header field at network boundaries (autonomous system boundaries, internal administrative boundaries, or hosts), using those bits to determine how packets are forwarded by the nodes inside the network, and conditioning the marked packets at network boundaries in accordance with the requirements or rules of each service.

Differentiated Services defines an edge router at the network boundary, and core routers within the network. The edge and core routers have different duties. The edge router must condition the traffic to ensure that it conforms to the service agreement. It also marks the traffic with the appropriate DSCP (Differentiated Services Code Point). It then forwards the packet according to the service behavior defined for that DSCP. The service behavior, called the Per Hop Behavior (PHB) may define the prioritization or weighting of that traffic to give it better service than other traffic. The core nodes examine the DSCP and apply the service behavior appropriate for that service. FIG. 4 shows an end-to-end service. The DS edge routers perform the traffic conditioning, while the DS core routers simply apply the PHB.

Services may be constructed by a unique combination of PHB and traffic conditioning. For example, two different services can be created using the same PHB by applying a different traffic conditioning function at the edge routers.

The IntServ architecture provides a means for the delivery of end-to-end QoS to applications over heterogeneous networks. To support this end-to-end model, the IntServ architecture must be supported over a wide variety of different types of network elements. In this context, a network that supports Differentiated Services may be viewed as a network element in the total end-to-end path.

From the perspective of IntServ, DiffServ regions of the network are treated as virtual links connecting IntServ capable routers or hosts (much as an ethernet LAN can be treated as a virtual link). Within the DiffServ regions of the network, routers implement specific PHBs (aggregate traffic control). The total amount of traffic admitted into the DiffServ region that will receive a certain PHB is controlled by the conditioning at the edge routers. An IntServ service can be provided across a DiffServ domain by applying admission control and traffic conditioning at the edge router to meet the IntServ service specification, and signaling the RSVP service characteristics of the DiffServ domain to the next RSVP enabled router. The information provided in the RSVP signaling should be appropriate for the service across the DiffServ domain. This is shown in FIG. 5.

To realize a QoS Service with clearly defined characteristics and functionality, a QoS bearer must be set up from the source to the destination of the service. A bearer is a logical connection between two entities through one or more interfaces, networks, gateways, etc., and usually corresponds to a data stream. A QoS bearer service includes all aspects to enable the provision of a contracted QoS. These aspects are among others the control signaling, user plane transport, and QoS management functionality.

Mobile Radio Access Data Networks, like General Packet Radio Service (GPRS) and Universal Mobile Telecommunication System (UMTS), may form a part of the overall network and will typically be a significant factor in the end-to-end bearer service for customers connected to it. Hence, the bearer service provided over a GPRS/UMTS network must provide the required end-to-end bearer service.

The GPRS/UMTS network includes a set of network elements between the host, referred to as the Mobile Station (MS), and an external packet switching network the user is connecting to like the Internet. These network elements are shown in FIG. 6. The radio access network (RAN) provides access over the radio interface to/from the MS. The RAN is coupled to a supporting gateway Gateway GPRS Support Node (SGSN) and a Gateway GPRS Support Node (GGSN). The GGSN provides the interworking with external packet-switched networks.

Before a mobile host can send packet data to an external host, the mobile host must “attach” to the GPRS network to make its presence known and to create a packet data protocol (PDP) context to establish a relationship with a GGSN towards the external network that the mobile host is accessing. The PDP attach procedure is carried out between the mobile host and the SGSN to establish a logical link. As a result, a temporary logical link identity is assigned to the mobile host. A PDP context is established between the mobile host and a GGSN selected based on the name of the external network to be reached. One or more application flows (sometimes called “routing contexts”) may be established over a single PDP context through negotiations with the GGSN. Again, an application flow corresponds to a stream of data packets distinguishable as being associated with a particular host application. An example application flow is in an electronic mail message from the mobile host to a fixed terminal. Another example application flow is a link to a particular Internet Service Provider (ISP) to download a graphics file from a website. Both of these application flows are associated with the same mobile host and the same PDP context.

User data is transferred transparently between the MS and the external data networks with a method known as encapsulation and tunneling: data packets are equipped with PS-specific protocol information and transferred between the MS and the GGSN.

Quality of Service (QoS) has an extremely important and central role in 3^{rd} generation (3G) UMTS mobile networks. QoS is a means for providing end users with satisfying service. QoS also enables efficient use of the spectrum of resources. Because the invention will be described in terms of a UMTS QoS architecture, a brief overview of QoS in UMTS is provided. The 3G UMTS QoS architecture is described, including an explanation of the packet data protocol context (PDP context), a traffic flow template (TFT), and the QoS maintenance procedures for activated UMTS bearers. It is expected that the QoS characteristics associated with a radio communication are the most critical in the end-to-end chain. Within UMTS access networks, the radio network resources are managed on a per PDP context level, which corresponds to one or more user flows/data streams and a certain QoS level.

The QoS framework for 3G networks is specified in the 3G specification (3GPP) TS23.107. The main focus is on the QoS architecture to be used in the UMTS level, where the list of QoS attributes applicable to UMTS Bearer Service and the Radio Access Bearer Service are specified along with appropriate mapping rules. TS23.060 specifies the general mechanisms used by data packet connectivity services in the UMTS level, which includes the General Packet Radio Service (GPRS) in GSM and UMTS.

In a UMTS QoS Architecture, a network service is considered to be end-to-end, from a Terminal Equipment (TE) to another TE. To realize a certain end-to-end QoS, a bearer service with clearly defined characteristics and functionality is set up from the source to the destination of a service. Again, the bearer service includes those aspects needed to enable the provision of a contracted QoS, e.g., control signaling, user plane transport, QoS management and functionality.

A UMTS bearer service layered architecture is depicted in FIG. 7. Each bearer service on a specific layer offers its individual services using services provided by the layers below. Bearers at one layer are broken down into underlying bearers, each one providing a QoS realized independently of the other bearers. Service agreements are made between network components, which are arranged horizontally in FIG. 7. The service agreements may be executed by one or more layers of service. For instance, the UMTS bearer service consists of a Radio Access Bearer (RAB) service and a Core Network (CN) bearer service. The RAB services is then divided into a radio bearer service and a Iu bearer service. The Iu interface is the interface between the radio access network and the core network.

The following are examples of the entities shown in FIG. 7. The terminal equipment (TE) may be a laptop and the mobile terminal (MT) may be a cellular radio handset. The UTRAN may be made up of a combination of radio base stations called Node B's and radio network controllers (RNCs). The Core Network (CN) Iu Edge Node may be a serving GPRS support node (SGSN), and the CN Gateway may be a gateway GPRS support node (GGSN).

The QoS management functions in UMTS are used to establish, modify and maintain a UMTS Bearer Service with a specific QoS, as defined by specific QoS attributes. The QoS management functions of all the UMTS entities ensure provision of the negotiated UMTS bearer service.

The UMTS architecture comprises four management functions in the control plane and four in the user plane. The four control plane management functions are shown in FIG. 8.

Bearer Service (BS) Manager sets up, controls, and terminates the corresponding bearer service. Each BS manager also translates the attributes of its level to attributes of the underlying bearer service during service requests.

Translation function converts between external service signaling and internal service primitives including the translation of the service attributes, and is located in the MT and in the CN Gateway.

Admission/Capability control determines whether the network entity supports the specific requested service, and whether the required resources are available.

Subscription Control determines whether the user has the subscription for the bearer being requested.

The four user plane management functions are:

Classification function resides in the GGSN and in the MT. It assigns user data units (e.g. IP packets) received from the external bearer service from the remote terminal (or the local bearer service) from the local terminal to the appropriate UMTS bearer service according to the QoS requirements of each user data unit. This is where the traffic flow template (TFT) and packet filters are situated, as described below.

Mapping function marks each data unit with the specific QoS indication related to the bearer service to which it has been classified. For example, it adds different service code points to packets before putting them on the Iu or CN bearer.

Resource Manager distributes its resources between all bearer services that are requesting use of these resources. The resource manager attempts to provide the QoS attributes required for each individual bearer service. An example of resource manager is a packet scheduler.

Traffic conditioner is a shaping and policing function which provides conformance of the user data traffic with the QoS attributes of the concerned UMTS bearer service. This resides in the GGSN and in the MT as well as in the UTRAN.

The QoS management functions of the UMTS bearer service in the user plane are shown in FIG. 9. These functions together maintain the data transfer characteristics according to the commitments established by the UMTS bearer service control functions, expressed by the bearer service attributes. The user plane uses the QoS attributes. The relevant attributes are provided to the user plane management functions by the QoS management control functions.

Four different QoS classes standardized in UMTS are shown in FIG. 10. Data transport may be optimized for the corresponding type of application data or for a bearer service of a certain class. The main distinguishing factor between these classes is how delay sensitive the traffic is: Conversational class is meant for traffic which is very delay sensitive (for real-time services) while Background class is the most delay insensitive traffic class (for non-real time services). Other differences between the classes include bit error rate and packet loss rate.

To characterize a bearer service in detail, a set of bearer service attributes are standardized in UMTS as shown in the tables referenced below. A certain QoS is requested by selecting a set of attribute values that describes the bearer requirement. Parameters differ depending on the type of bearer service requested. FIG. 11 shows which attributes that are applicable to which traffic class.

FIG. 12 provides an overview of uses for different QoS attributes. The exact definitions of the QoS attributes can be found in TS23.107. A subscription is associated with one or more Packet Data Protocol (PDP) addresses, i.e., IP addresses in the case of IP traffic. Each PDP address is described by one or more PDP contexts stored in the MS, the SGSN, and the GGSN. Default values are also available in the cellular system data base, e.g., the HLR, which holds the subscription information. Each PDP context may be associated with a Traffic Flow Template (TFT). At most, one PDP context (associated with the same PDP address) may exist at any time with no TFT assigned to it. The relationship between PDP address, PDP context, and TFT is provided in FIG. 13.

A PDP context is implemented as a dynamic table of data entries, comprising all needed information for transferring PDP PDUs between MS and GGSN, for example addressing information, flow control variables, QoS profile, charging information, etc. The relation between UMTS bearer services and PDP context is a one-to-one mapping, i.e., if two UMTS bearer services are established for one PDP address, two PDP contexts are defined. The PDP context procedures are standardized in TS23.060. The concepts surrounding the QoS profile and the Traffic Flow Template (TFT) are relevant from the QoS perspective.

The UMTS QoS attributes have been selected and defined mainly for supporting efficient radio realization. A QoS profile is defined by a set of UMTS QoS attributes. The RNC obtains the pertinent radio access bearer (RAB) QoS profile from the SGSN during PDP context activation. There are three different QoS profiles involved in a PDP context activation—the requested QoS profile, the negotiated QoS profile, and the subscribed QoS profile (or the default QoS profile).

A Traffic Flow Template (TFT) is a packet filter (or set of filters) that associates packets to the correct PDP context thereby ensuring that packets are properly forwarded with correct QoS characteristics. The TFT enables the possibility of having several PDP contexts with varying QoS profiles, associated to a single PDP address. The TFT is managed and initiated by the MT both for the uplink and downlink flows. The uplink TFT resides in the MT, while the downlink TFT resides in the GGSN. The downlink TFT is sent from the MT to the GGSN during PDP context activation/modification. The downlink TFT's may be added to a PDP context that was created without one, and the contents may be modified as well.

FIG. 14 shows TFT packet filter attributes and valid combinations. Each TFT has an identifier and an evaluation precedence index that is unique within all TFT's associated with the PDP contexts that share the same PDP address. The MS manages the identifiers and the evaluation precedence indices of the TFT's, as well as the packet filter contents. Some of the attributes in FIG. 14 may coexist in a packet filter while others mutually exclude each other. Only those attributes marked with an “X” may be specified for a single packet filter. All the marked attributes may be specified, but at least one has to be specified.

The PDP context signaling carries the requested and negotiated QoS profile between the nodes in the UMTS network. It has a central role for QoS handling in terms of admission control, negotiation, and modifying of bearers on a QoS level. The PDP context signaling message exchanges are described below with reference to the numerals in FIG. 15.

1. An RRC connection establishment is performed. This procedure is needed for establishing a connection, but does not cover more from a QoS perspective than that the type of radio channel is roughly indicated.

2. The MS sends a PDP message, “Activate PDP context request,” to the SGSN. The requested QoS profile is included in this message. At this stage, the SGSN makes an admission check and might restrict the requested QoS if the system is overloaded.

3. The SGSN sends a RANAP message, “RAB Assignment Request,” to the RNC in the UTRAN. RANAP, or Radio Access Network Application Part, is an application protocol for supporting signaling and control transmission between the UTRAN and the external CN. RANAP permits communication between the UTRAN and circuit-switched or packet-switched networks. This request to establish a radio access bearer (RAB) service carries the (perhaps modified) RAB QoS attributes.

4. From the RAB QoS attributes, the RNC determines the radio-related parameters corresponding to the QoS profile, e.g., transport format set, transport format combination set, etc. In addition, the UTRAN performs an admission control on this bearer.

5. The RNC sends an RRC message, “Radio Bearer Set-up,” to the MS. The RRC message includes the radio-related parameters that were determined in step 4.

6. The UTRAN and the MS apply the radio parameters and are ready to transfer traffic. To signal this, the MS sends a “Radio Bearer Set-up Complete” RRC message to the RNC.

7. The UTRAN sends a “RAB Assignment Complete” RANAP message to the SGSN.

8. A Trace procedure may be initiated. This is an operation and maintenance function for surveying subscribers.

9. The SGSN sends a “Create PDP Context Request” to the GGSN carrying the QoS profile. However, the QoS profile may have different parameters than those requested by the MS in step 2. Based on this profile, an admission control is performed at the GGSN level, and the GGSN may restrict the QoS if, for example, the system is overloaded. The GGSN stores the PDP context in its databases.

10. The GGSN returns the negotiated QoS to the SGSN in a “Create PDP Context Response” message and the SGSN stores the PDP context in its database.

11. The negotiated QoS is sent from the SGSN to the MS in an “Activate PDP Context Accept” message. If either the SGSN or the GGSN has modified the QoS profile, then the MS has to either accept or reject this profile.

Several admission controls take place in the procedure. Because bandwidth associated with radio is the most expensive resource, the UTRAN is consulted in determining whether radio resources are available during PDP context activation or modification. In other words, admission control in UMTS is performed in a radio centric manner.

To provide IP QoS end-to-end, it is necessary to manage the QoS within each domain. An IP BS Manager in the Gateway is used to control the external IP bearer service. Due to the different techniques used within the IP network, this is communicated to the UMTS BS manager through the Translation function. There is a likewise a need for an IP bearer service manager function to be provided in UE, where the bearer service manager maps the QoS requirements of the application to the appropriate QoS mechanisms. FIG. 16 shows the embodiment for control of an IP service using IP BS Managers in both possible locations in the UE and Gateway node. FIG. 16 also indicates the optional communication path between the IP BS Managers in the UE and the Gateway node. The IP BS Managers use standard IP mechanisms to manage the IP bearer service. These mechanisms may be different from mechanisms used within the UMTS, and may have different parameters controlling the service. The translation/mapping function provides the interworking between the mechanisms and parameters used within the UMTS bearer service and those used within the IP bearer service, and interacts with the IP BS Manager. If an IP BS Manager exists both in the UE and the Gateway node, it is possible that these IP BS Managers communicate directly with each other by using relevant signaling protocols.

An IP Multimedia Service (“IMS”) may be defined “on top” of the GPRS bearer service to provide multimedia sessions to end users. The quality of service aspects of bearers supporting IP multimedia is specified in the 3GPP TS 23.207, and the IP multimedia specification is set forth in the 3GPP TS 23.228. The IMS is based on IP application signaling, which in a preferred, example embodiment includes session initiation protocol (SIP) and session description protocol (SDP). SIP is a signaling protocol to establish sessions, and SDP is a text-based syntax to describe the session and includes, for example, the definition of each media stream in the session.

For multimedia sessions, it is important that network managers and services providers be able to monitor, control, and enforce the use of network resources and services based on “policies” derived from certain established criteria such as the identity/authority level of users and applications, traffic bandwidth requirements, security considerations, time of day/week, etc. Because there are varying circumstances in which various entities are entitled to use the services they request, there is a need for rules, a need for enforcement methods of these rules, and a need for a “judge” to decide when they apply. Accordingly, three major components of a policy system include policy rules, which are typically stored in a policy database, policy enforcement, which may be implemented at Policy Enforcement Points (PEP), and Policy Decision Points. The IETF has standardized a protocol for information exchange between PEPs and Policy Decision Points under the term Common Open Policy Service (COPS). In general, a policy may be regarded as a collection of rules that result in one or more actions when specific conditions exist.

Session level policy controls, such as the service-based local policy control described in commonly-assigned U.S. patent application Ser. No. 09/861,817, entitled “Application Influenced Policy,” cannot automatically be applied to PDP contexts unless the relationship of the various media streams to the PDP contexts is known. That is because such relationships are under the control of the end user establishing the multimedia session, the various media streams, and the corresponding quality of service parameters associated with those media streams.

Two of the commonly-assigned applications referenced above, U.S. patent application Ser. No. ______, entitled “Method and Apparatus for Coordinating Quality of Service Requirements for Media Flows in a Multimedia Session With Bearer Resources,” filed on Nov. 5, 2001; and U.S. patent application Ser. No. ______, entitled “Media Binding to Coordinate Quality of Service Requirements for Media Flows in a Multimedia Session With IP Bearer Resources,” filed on Nov. 5, 2001, describe mechanisms for communicating effectively and efficiently the relationship between a session, media flows in that session, and the quality of service required by each media flow in order to request, reserve, supply, and enforce the resources necessary to support each media flow at the IP/PDP bearer level. These mechanisms facilitate interworking and cooperation in end-to-end user sessions where the backbone network uses one protocol, e.g., RSVP, to manage/reserve backbone resources for a session while the mobile terminal/UMTS network uses another protocol, e.g., PDP context information, to interwork with backbone quality of service reservation/management mechanisms.

Multimedia sessions provide operators with opportunities and challenges when it comes to charging for multimedia session services. Certain network operators may want to charge subscribers separately for using the GPRS access network (or a similar access network) using one charging metric, e.g., charge per unit of data, and for session level services using another charging metric, e.g., charge per unit time. However, it is more likely that many may want to issue a single charge for using a multimedia service. One reason is to simplify subscriber bills and accounting. Another reason is to permit network operators to offer a single multimedia session charge which is less than the sum of plural separate charges associated with each separate service employed in a multimedia session.

A further factor to consider is that some operators intending to offer IP multimedia services may want to charge according to established GSM charging principles. This means, among other things, that charges for use of the GPRS access network would be based on time and quality of service. It also means that all of the components involved in the call should be linked together to permit accurate charging considering the time, locations of subscribers, type of service, type of access, etc. It may further include the possibility for an “A-party pays” charging model, where the originating party/side pays for the cost of the entire session just like what is available today in GSM when the terminating B-party is not roaming. For this case, all components involved in the call from both the A-party side and the B-party side should be linked together. Yet another factor is the desirability of linking service-based local policy (SBLP) enforcement, (e.g., as described in U.S. patent application Ser. No. 09/861,817, entitled “Application Influenced Policy,” filed on May 21, 2001), to multimedia session charging.

These and perhaps other factors point to a need for a mechanism to correlate charging information associated with an IP multimedia system which services a multimedia call on a session level and charging information associated with an access bearer network for services provided in the multimedia session on a PDP context/bearer access level to allow operators to take advantage of the information received from both levels to provide flexibility in charging for multimedia sessions.

The present invention provides a mechanism for coordinating charging for a multimedia session between a mobile terminal and a remote host on both an application/session level and on an IP/access bearer level. The multimedia session is established over a radio access network via a packet-switched access network coupled to a multimedia system. The multimedia system has one or more multimedia servers for providing multimedia services for multimedia sessions. A token associated with the multimedia session is generated. Using the token, session charges associated with the multimedia session are correlated for a first operation performed in the packet-switched access network and for a second operation performed by the multimedia system. A first entity in the packet-switched access network includes the session token in a first charging message associated with the session sent to a charging entity. A second entity in the multimedia system includes the session token in a second charging message associated with the session to be sent to the charging entity.

The charging messages may take any number of forms including, for example, first and second call data records (CDRs), first and second charging instances, and different types of charging messages, such as a Customized Applications for Mobile network Enhanced Logic (CAMEL) charging message used in some GSM networks for the first charging message, and a DIAMETER-based charging message used in some IP networks for the second charging message. The first charging message might include, for example, information relating to access bearer services, e.g., location of the mobile terminal, location of the remote host, volume of packets sent or received, quality of service parameters associated with one or more of the packet access bearers employed in the multimedia session, and times. The second charging message may include information related to multimedia services provided at a session level such as type of multimedia service, identity of originating and terminating entities, service-based local policy restrictions, discounted charging scenarios, and amount of time in which session resources are used.

In a non-limiting, example detail, the token may include a session identifier which may, together with a flow identifier generated by the mobile terminal, be used to identify the specific session media flow that will use the packet access network bearer to be correlated to the session. That bearer-specific token may be used to correlate bearer level charges for each media data stream with session level charges for each media data stream.

The token may also be used by the mobile terminal to indicate whether the mobile terminal agrees to a certain charging arrangement for the multimedia session. For example, when the token is issued by the home network operator, the fact of the mobile terminal sending that token to the packet-switched access network may indicate that the mobile terminal agrees to a charging arrangement for the multimedia session where bearer level and session level services for the session are combined or bundled together, rather than charged for separately as they would be if the token was not sent. In addition, sending the token to the packet access network may indicate the mobile terminal's agreement to a service level contract with a home network operator. In either situation, the home network operator issued token is used by the charging entity to correlate or bundle together session level and bearer level services for charging purposes.

The token may be issued by an entity associated with a visited network operator. In this case, the mobile terminal may indicate agreement to service-based local policy (SBLP) enforcement of bearer services in the visited network by sending the token to the packet access network. The packet access network may then send an indication of SBLP enforcement to the charging entity so that the charging entity can take such SBLP into account in charging, e.g., charge at a discounted rate to reward the UE for submitting to SBLP.

In a preferred, non-limiting, example application of the present invention, the mobile terminal is coupled to an IP-based multimedia system (IMS) that provides multimedia services by way of a GPRS network. A service charge identifier corresponding to the session is provided to an IMS entity in the IMS and to a GPRS entity in the GPRS network. Charges relating to services provided in the IMS and in the GPRS network for the session are correlated using the service charging identifier.

The IMS entity may be a call state control function (CSCF) which generates the service charge identifier and sends it to the mobile terminal. If the CSCF is a Serving-CSCF (S-CSCF) associated with the mobile's home network, the mobile terminal can indicate agreement to a service charging arrangement simply by sending the service charging identifier generated by the S-CSCF to the GPRS network. This service charging identifier also allows the charging entity to “bundle” the session level service charges with the PDP context/GPRS bearer level services into one service charge.

The IMS entity generating the service charging identifier may be a Proxy-CSCF (P-CSCF) associated with a network visited by the mobile terminal. As described above, the fact of the mobile terminal sending the service charging identifier to the GPRS network may be used to indicate the mobile's agreement to service-based local policy (SBLP) enforcement of bearer services at the GPRS network level based on policy information for the session provided by the P-CSCF to a gatekeeper node in the GPRS network. The gatekeeper may send an “SBLP-implemented indicator” to the charging entity to indicate that SBLP has been applied in this session. The charging node may take into account that SBLP application in formulating the session charges, e.g., provide a discount to reward the user for agreeing to SBLP in the visited network.

In a preferred example implementation detail, the mobile terminal includes the service charging identifier in a packet data protocol (PDP) context message sent to a node in the GPRS network. The service charging identifier may be included in a PDP configuration options (PCO) field. If the GPRS node is a serving GPRS support node (SGSN), the SGSN may send the service charging identifier with charging information via the GSM-Camel interface for pre-paid services/real-time charging or via a call data record (CDR) for off-line charging to a home network cost control node. The cost control node may perform a variety of charging operations including bundled bearer-service charging, real-time charging, or prepaid charging. A gateway GPRS support node (GGSN) may employ the service charging identifier in a PDP context response message to the SGSN and/or in service based local policy (SBLP) setup, enforcement, and/or charging. The GGSN may send the service charging identifier with charging information via CDR for off-line charging to a home network cost control node.

In another preferred example implementation detail, where a calling party A has a session established with a called party B, a common service charging identifier is passed on to their respective packet-switched access networks and multimedia systems. The common service charging identifier is used by one or more charging nodes to correlate the charges from both A and B sides. This approach facilitates the “A-party pays” charging model, where the originating side party A pays for the cost of the entire session just like what is available today in GSM when the terminating B-party is not roaming. Alternatively, each side uses its own service charging identifier, and the correlation of the two service charging identifiers is carried out via communication between the two charging nodes. Using different service charging identifiers eliminates the need for a global service charging identifier for the session, which is more difficult to handle/standardize.

### BRIEF DESCRIPTION OF THE DRAWINGS

The foregoing and other objects, features, and advantages of the present invention may be more readily understood with reference to the following description taken in conjunction with the accompanying drawings.

FIG. 1 is a block diagram of a high level IP network;

FIG. 2 is a block diagram depicting an example of a network employing end-to-end integrated services;

FIG. 3 is a block diagram depicting an example of a network employing an RSVP proxy;

FIG. 4 is a block diagram depicting an example of a network employing end-to-end differentiated services;

FIG. 5 is a block diagram depicting an example of a network employing RSVP signaling interworking with differentiated services;

FIG. 6 is a block diagram depicting a mobile access data network modeled as a DiffServ network;

FIG. 7 is a block diagram of a UMTS quality of service architecture;

FIG. 8 is a block diagram depicting quality of service management for UMTS bearer services in the control plane;

FIG. 9 is a block diagram depicting quality of service management functions for UMTS bearer services in the user plane;

FIG. 10 is a table of UMTS quality of services classes;

FIG. 11 is a table of quality of service attributes;

FIG. 12 is a table providing an overview of some uses for the quality of service attributes illustrated in FIG. 11;

FIG. 13 is a block diagram of the relationship between PDP address, PDP context, and TFT;

FIG. 14 is a table of valid combinations of TFT packet filter attributes;

FIG. 15 is a diagram of PDP context message exchanges;

FIG. 16 is a block diagram of the quality of service management to functions for UMTS bearer services in the control plane and quality of service management functions for end-to-end IP quality of service;

FIG. 17 illustrates a communications system in which a multimedia session may be established between a mobile terminal and a remote host;

FIG. 18 illustrates in more detail a multimedia session in the communications system shown in FIG. 17;

FIG. 19 illustrates in flowchart form procedures for multimedia charging in accordance with an example embodiment of the present invention;

FIG. 20 illustrates a GPRS/UMTS-based communication system for conducting multimedia sessions in accordance with another example embodiment of the present invention;

FIG. 21 is a flowchart illustrating example procedures for multimedia charging for a multimedia session in the system shown in FIG. 19;

FIG. 22 is a flowchart illustrating example procedures implemented by a mobile terminal to facilitate multimedia charging using a service charging ID;

FIG. 23 is a flowchart illustrating example procedures implemented by a GPRS that may be implemented by a GPRS node for using a service charging ID in a number of different messages relating to the multimedia session;

FIG. 24 is a flowchart illustrating example procedures for a CSCF entity for generating and using a service charging identifier for a multimedia session;

FIG. 25 is a flowchart illustrating example procedures for a charging entity for receiving and correlating charging information for a multimedia session using a service charging identifier;

FIG. 26 illustrates a GPRS/UMTS-based communication system for conducting multimedia sessions showing session charging using two charging nodes;

FIG. 27 is a signaling diagram illustrating various signals for establishing and charging for a multimedia session in accordance with one example, non-limiting embodiment of the present invention; and

FIG. 28 is a signaling diagram illustrating various signals for establishing and charging for a multimedia session in accordance with another example, non-limiting embodiment of the present invention.

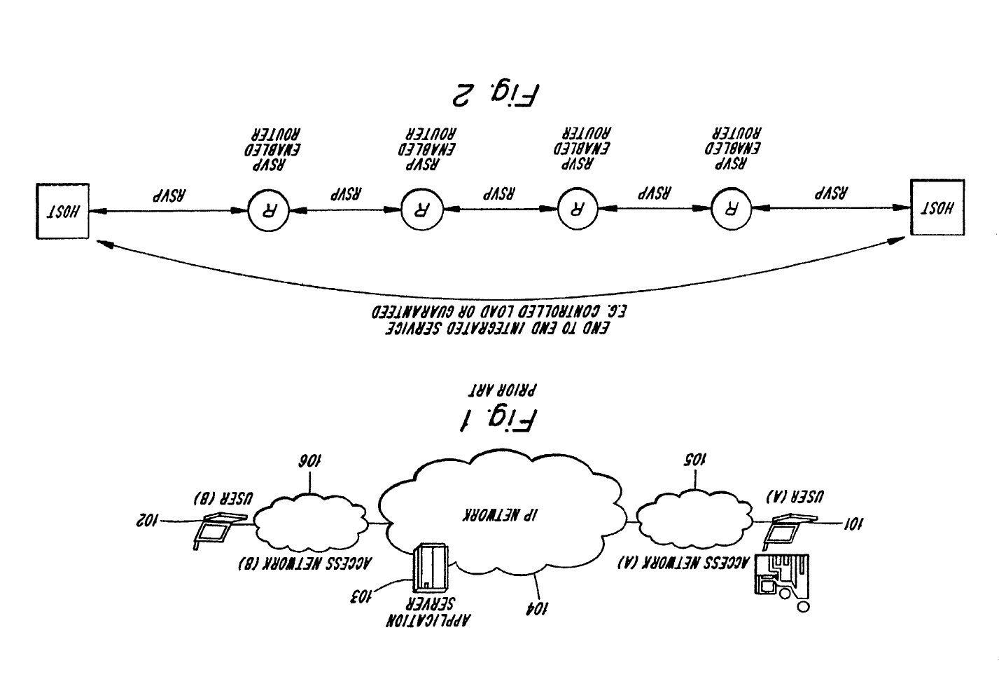

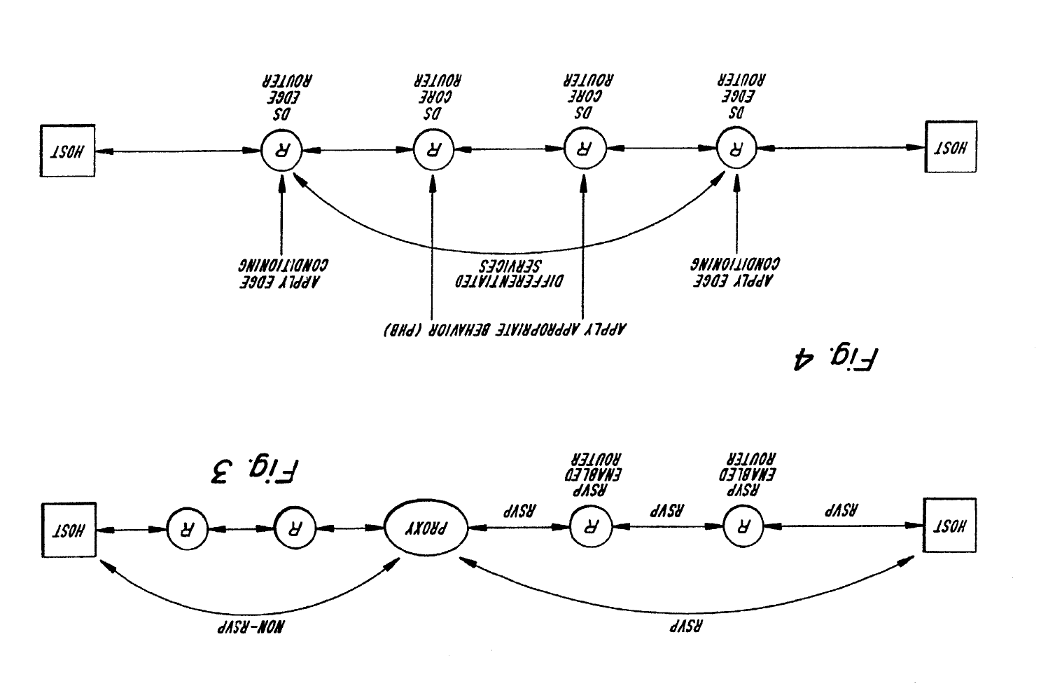

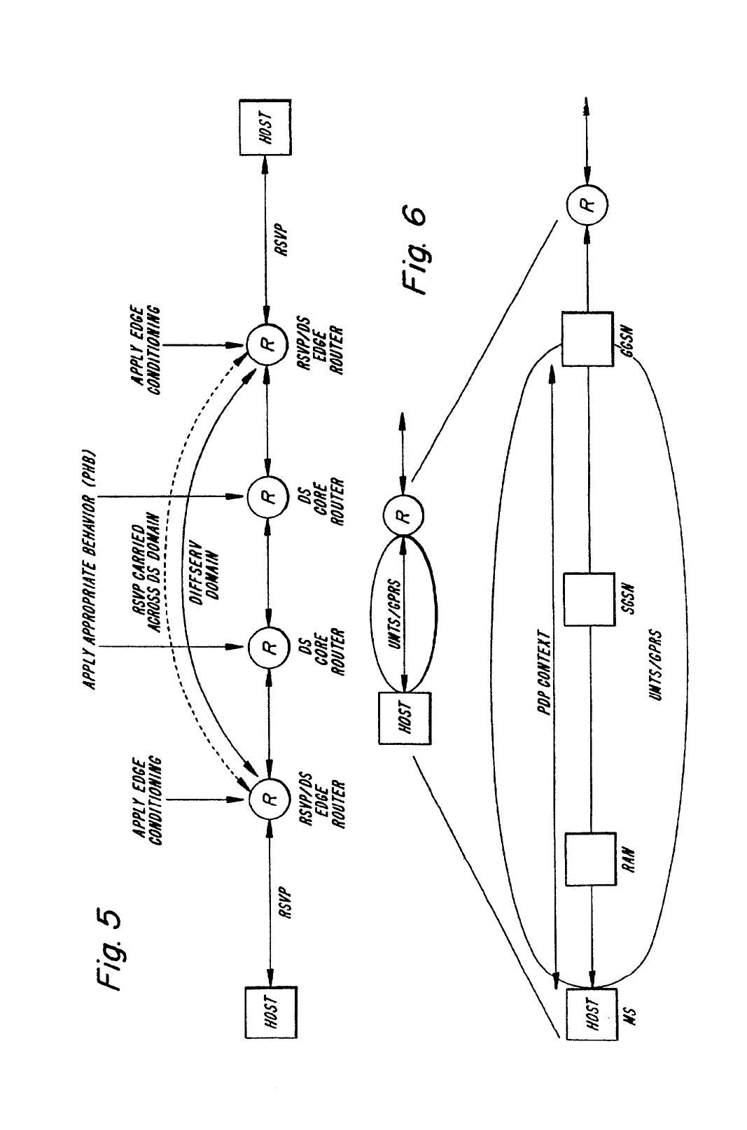

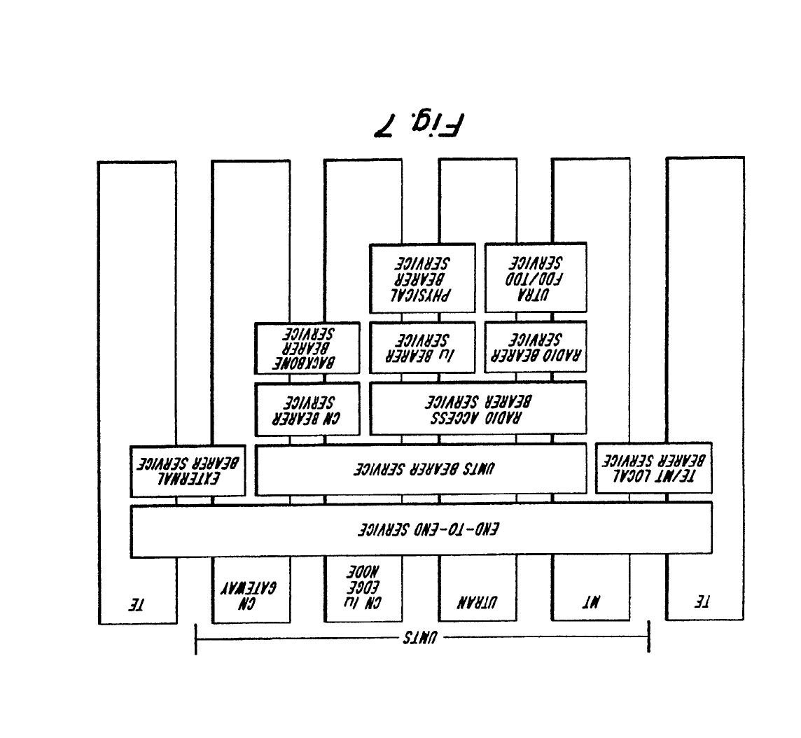

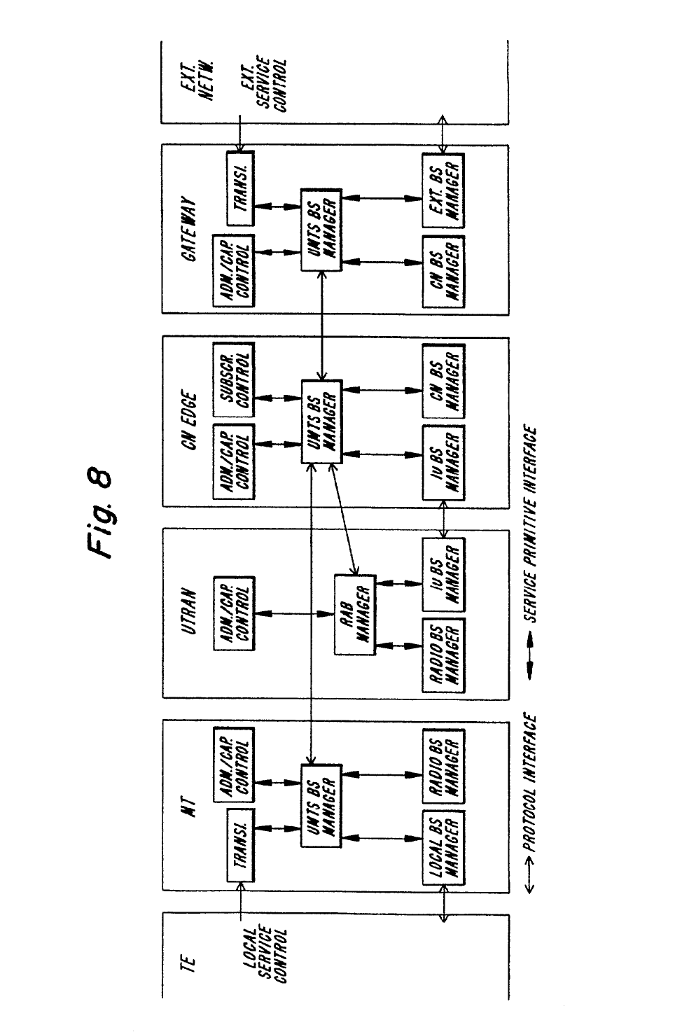

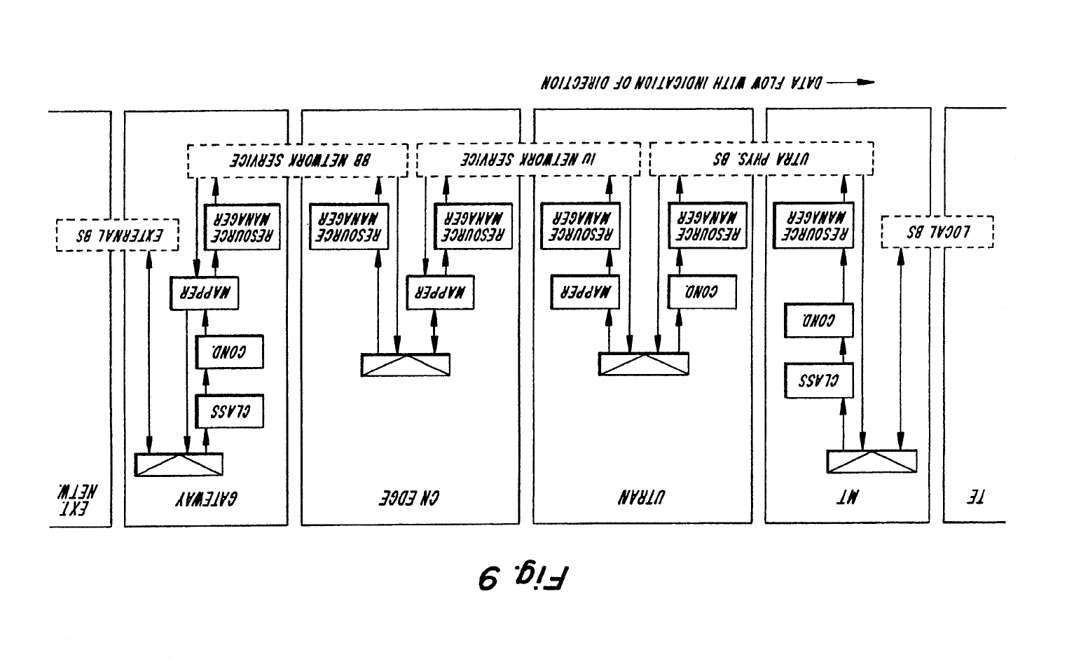

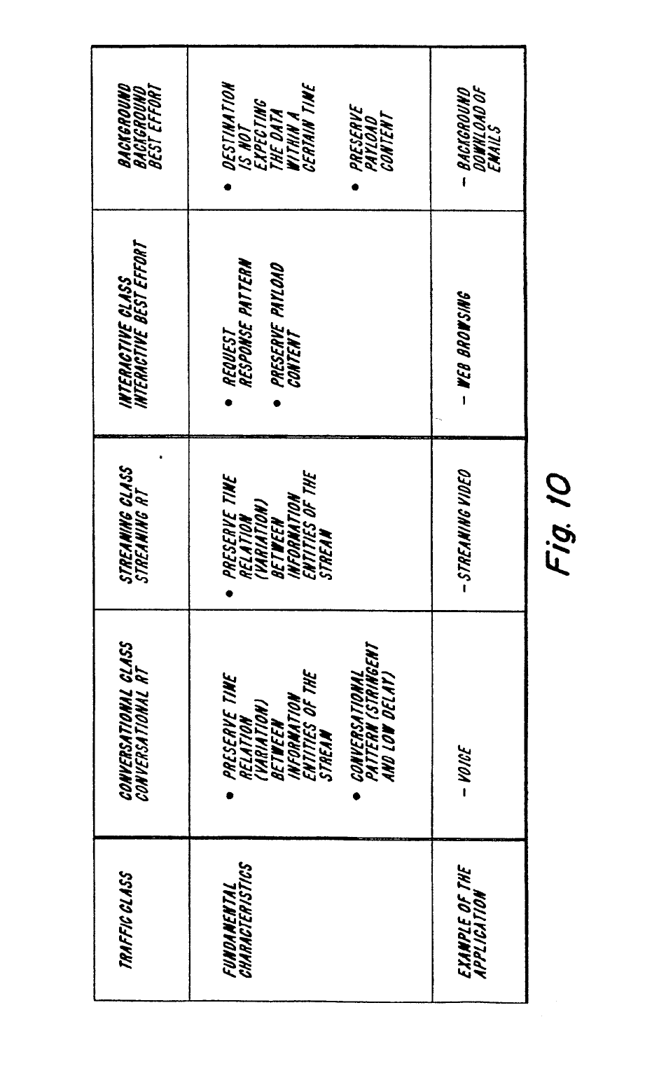

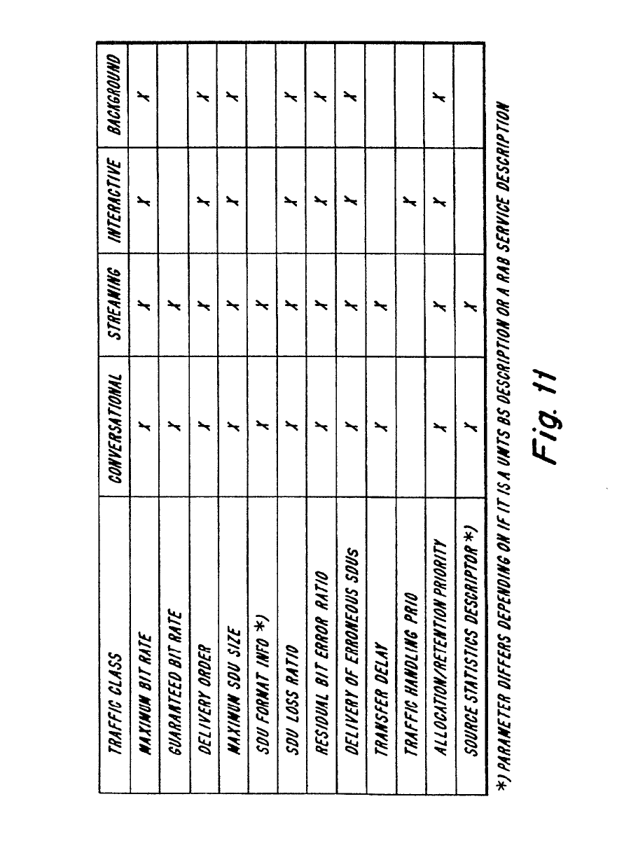

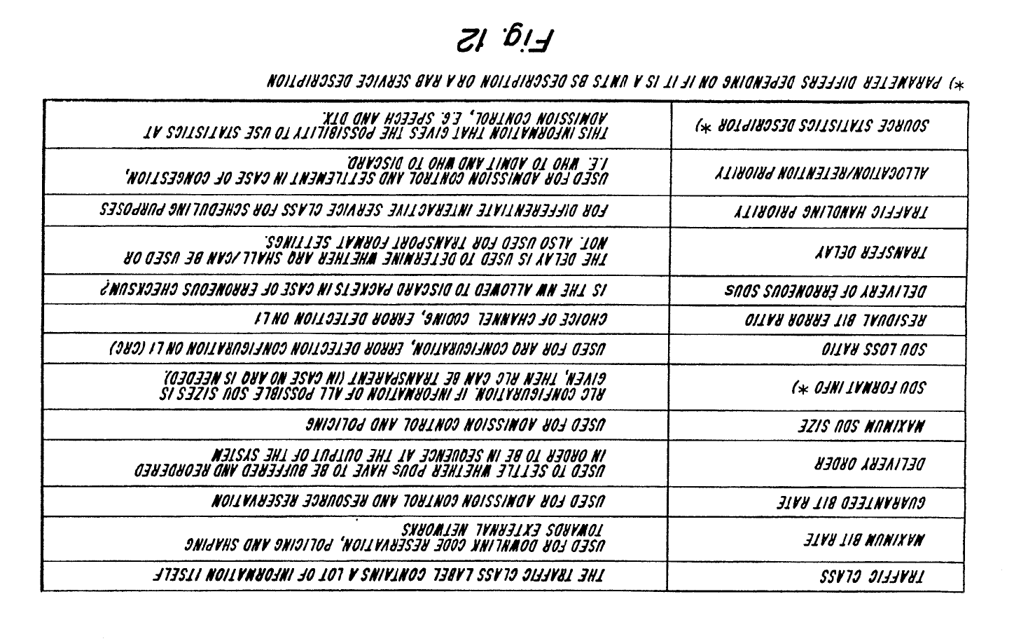

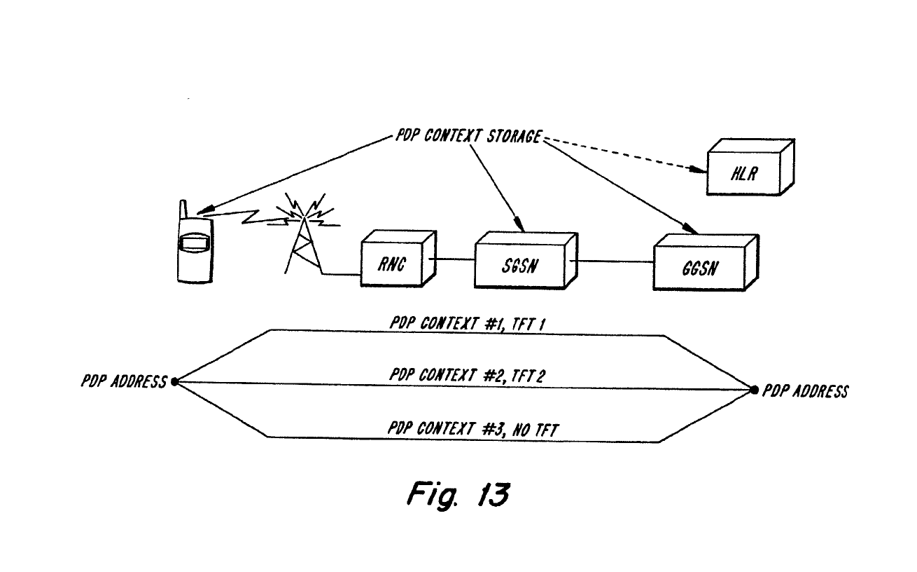

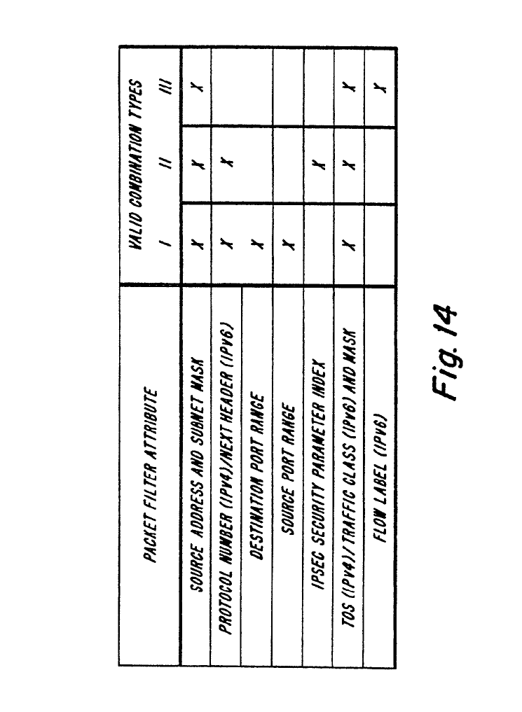

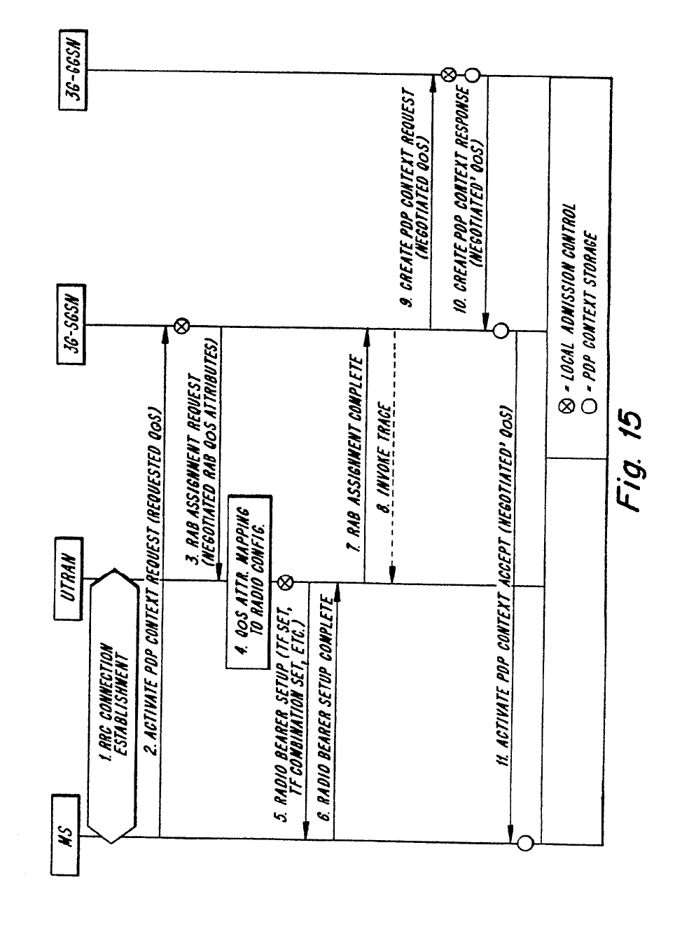

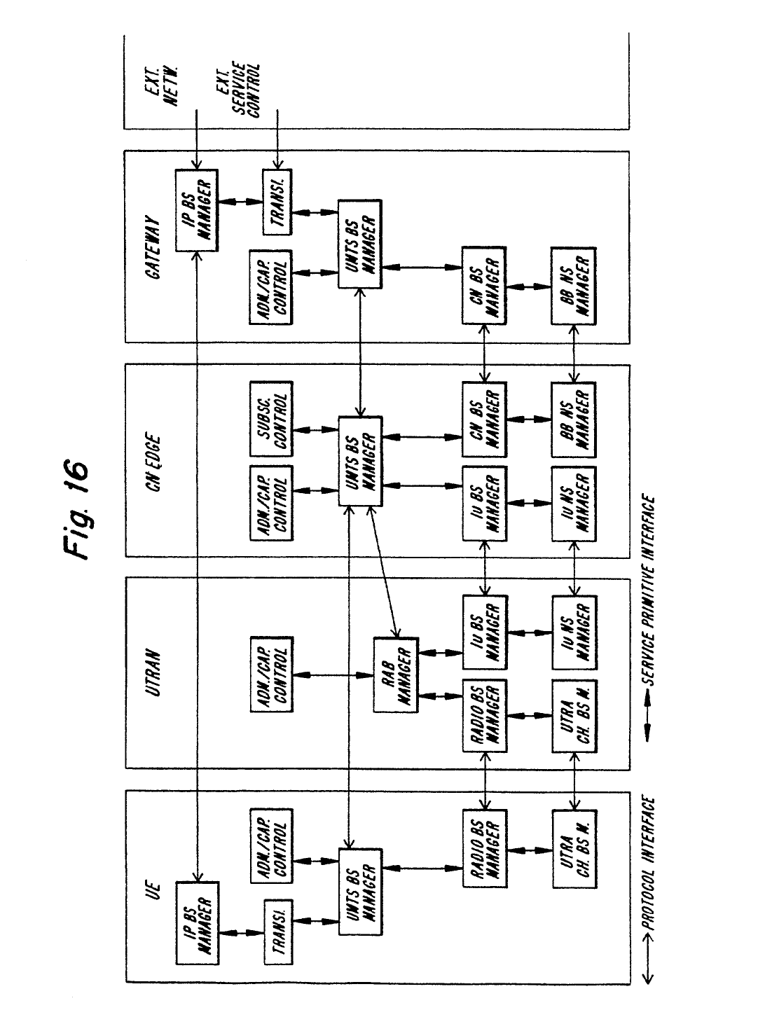

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while the present invention is described in an example application to GPRS/UMTS systems, the present invention may be employed in any cellular radio system that offers multimedia services.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

In the following description, a mobile terminal is used as one example of a user equipment (UE) allowing a user access to network services. In a mobile radio communications system, the interface between the user equipment and the network is the radio interface. Thus, although the present invention is described using the term “mobile terminal,” the present invention may be applied to any type or configuration of user equipment that can communicate over a radio interface.

As explained above, to provide IP quality of service end-to-end from mobile terminal to a remote host, it is necessary to manage the quality of service within each domain in the end-to-end path where each domain corresponds to a set of nodes using the same QoS mechanism. An IP bearer service manager may be used to control the external IP bearer service through the external packet data network, e.g., the Internet, to the remote host. However, there must be a way to interwork resources owned or controlled by the UMTS network and resources in the external packet data network. This is particularly important for multimedia-type communications between a mobile terminal and remote host.

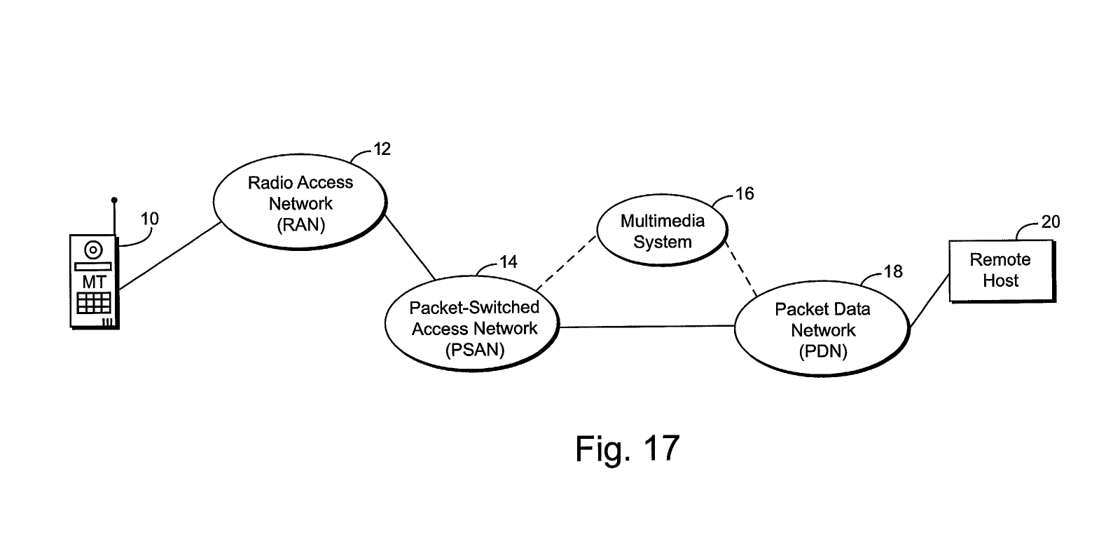

Consider the example, simplified communications system shown in FIG. 17 which permits a Mobile Terminal (MT) 10 to initiate and conduct a multimedia session with a remote host 20. The remote host can be a fixed or wireless device. The mobile terminal 10 is coupled to a radio access network (RAN) 12 over the radio interface. The RAN 12 is coupled to a packet-switched access network (PSAN) 14, which in turn is coupled to a Packet Data Network (PDN) 18 to which the remote host 20 is coupled. The basic traffic flow for a multimedia session (shown as solid lines) between the mobile terminal 10 and the remote host 20 is transported via these three networks 12, 14, and 18. The PSAN 14 and the PDN 18 communicate multimedia control signaling (shown as dashed lines) to a Multimedia System 16.

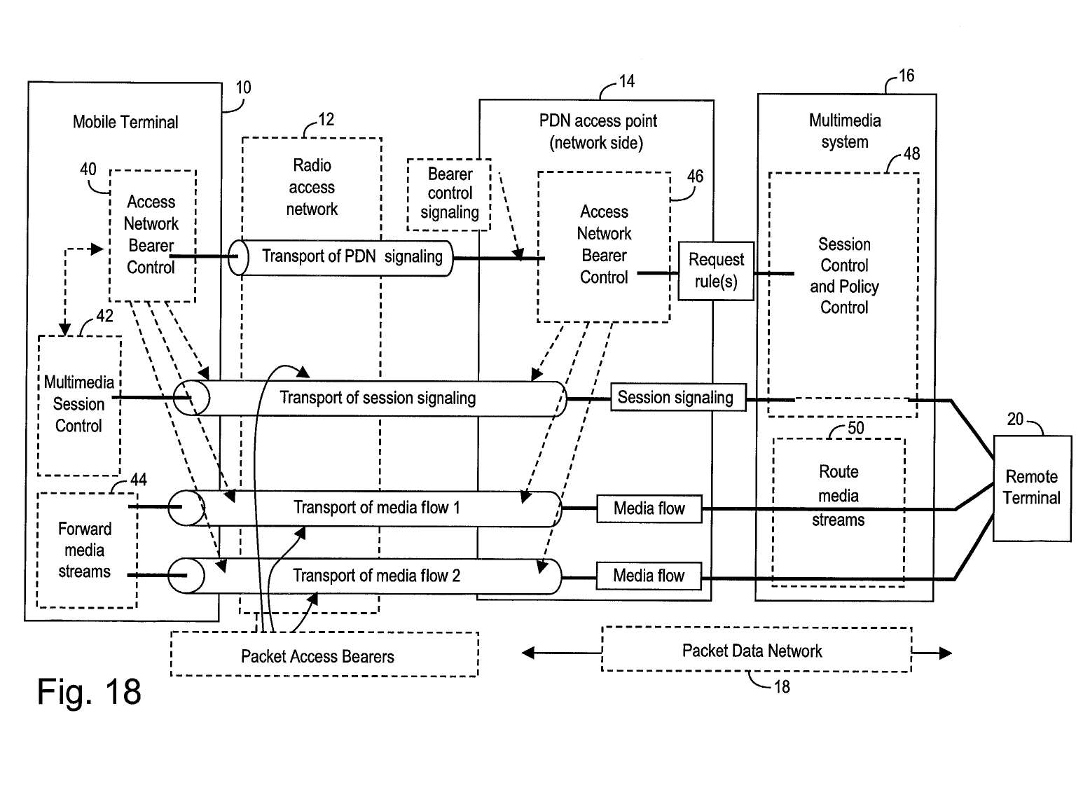

FIG. 18 illustrates, in a functional block diagram format, elements involved in setting up a multimedia session. The mobile terminal 10 includes Access Network Bearer Control 40 coupled to multimedia session control 42. The Access Network Bearer Control block 40 transports internal bearer control signaling, which is not dedicated to a particular session, to an Access Network Bearer Control block 46 in the packet data network access point 14 transparently over the radio access network over a PDN signaling transport bearer. Both Access Network Bearer Control blocks 40 and 46 assist in establishing a packet access bearer for setting up the session shown as the pipe entitled “transport of session signaling.” Over this bearer, the mobile terminal 10 initiates a multimedia session including a plurality of media data streams with the remote terminal 20. Each media data stream or “flow” is transported over a corresponding packet access bearer illustrated as a “transport of media flow” pipe coupled to a Forward Media Streams block 44 in the mobile terminal. Two media flows 1 and 2 are shown for purposes of illustration in this multimedia session. The multimedia system 16 in the packet data network 18 employs a Route Media Streams block 50 to route the packets in each media flow between the mobile terminal 10 and the remote terminal/host 20. Multimedia system 16 also includes a Session Control and Policy Control block 48 that utilizes the session signaling from the Multimedia Session Control block 42 in the mobile terminal 10 to correlate each multimedia flow and its corresponding quality of service requirements with the session to establish necessary admission and policy enforcement rules for the session. Those rules are provided upon request to the Access Network Bearer Control block 46 which performs admission and policy enforcement operations for the session in accordance with the obtained session rules.

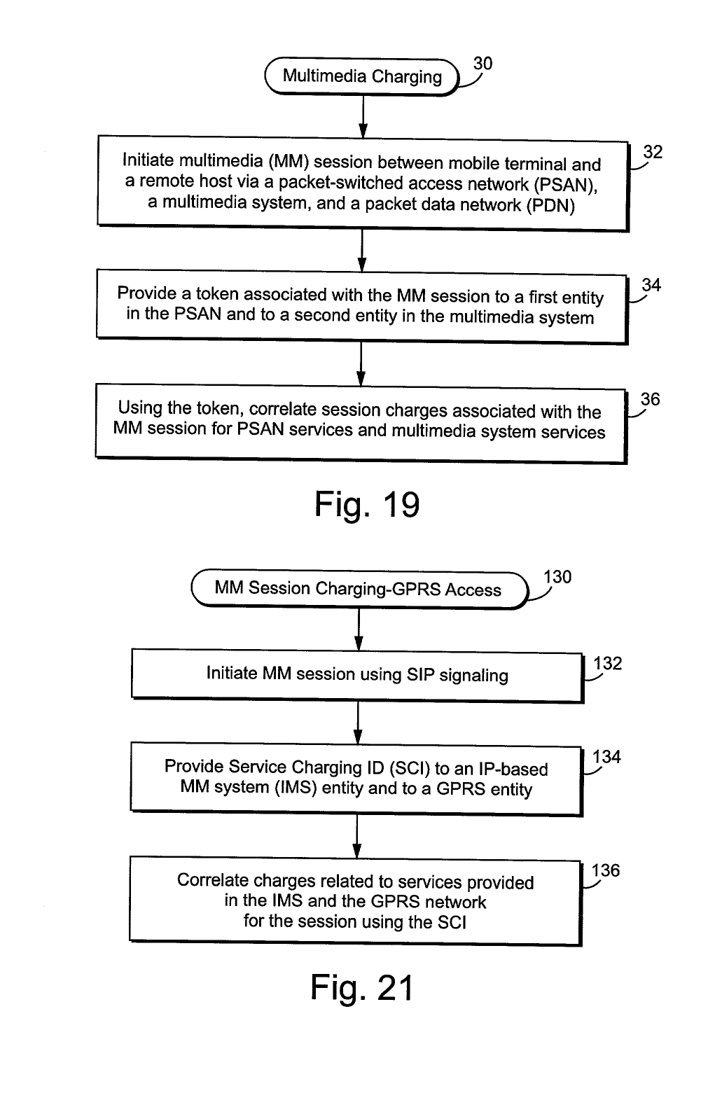

Reference is now made to a Multimedia Charging (block 30) set of procedures shown in flowchart format in FIG. 19. A multimedia (MM) session is initiated between a mobile terminal and a remote host via a packet-switched access network (PSAN), a multimedia system, and a packet data network (PDN) (block 32). A token associated with the multimedia session is provided to a first entity in the PSAN and to a second entity in the multimedia system (block 34). Using the token, session charges associated with the multimedia session are correlated for both PSAN services (access bearer level services) and multimedia system services (session level services) (block 36).

One charging message includes information related to access bearer-level services used for transporting each media stream in the session through the packet-switched access network. That charging information may include a number of different items, non-limiting examples of which include the following: location of the mobile terminal, location of the remote host, volume of packets sent or received, quality of service parameters, and time associated with one or more of the packet access bearers used in the session. Another charging message includes information related to session-level services used for controlling multimedia services requested for the session. That information may include, for example, one or more of the following: type of multimedia service, identity of originating and terminating entities, service-based local policy restrictions, discounted charging scenarios, and an amount of time in which session resources are used.

Methods for generating and using tokens to provide end-to-end IP quality of service, manage that quality of service, support for service-based local policy enforcement on individual multimedia flows in the session, and facilitate interworking of resources owned or controlled by a packet access bearer level network with resources in the external packet data network are described in detail in co-pending, commonly-assigned applications U.S. patent application Ser. No. ______, entitled “Method and Apparatus for Coordinating Quality of Service Requirements for Media Flows in a Multimedia Session With Bearer Resources,” filed on Nov. 5, 2001; and U.S. patent application Ser. No. ______, entitled “Media Binding to Coordinate Quality of Service Requirements for Media Flows in a Multimedia Session With IP Bearer Resources,” filed on Nov. 5, 2001. The present invention describes token-related functions relating to multimedia charging for a multimedia session.

The token may take on any number of forms, some of which convey general information, like a session identifier, or more specific information. Moreover, there may be situations where it is desirable to encrypt the token to ensure that there is no tampering with charges for the multimedia session. As an example of a more general information token, an access network identifier may be included with a session identifier and/or a multimedia system charging identifier for the session may be included with the session identifier. The charging node may use the session identifier and the identifiers associated with the access network and the multimedia system to generate a bundled “session-bearer” charge for the session.

As an example of a more specific information token, media-specific tokens may be employed to permit charging correlation both on a session level and on an individual bearer level. A media-specific token for each media data stream may be generated using a session identifier and a media stream identifier corresponding to that media data stream. The media-specific token is used to correlate individual bearer level charges for each media data stream with session level charges for each media data stream.

In example implementations, the token may be generated by one or more entities in the multimedia system or by the charging entity and sent to the mobile terminal. Moreover, the mobile terminal may send the token to the access network to indicate that the mobile terminal agrees to a particular charging arrangement for the multimedia session. For example, if the mobile terminal sends the token to the charging node via the packet-switched access network, that token may be interpreted by the charging node as an indication that the mobile terminal agrees to combined charging for bearer level and session level services. If the token is not received, then the charging node may charge for bearer level and session level services for the session separately. If the token is issued by an entity associated with the home network operator of the mobile terminal, the mobile may send the token to the packet-switched access network to indicate agreement to a service level contract with the home network operator. When the token is received at the charging node, the charging node takes that fact into account in the session charge. For example, the session charge may be discounted because the user agreed to the service level contract.

In another example embodiment, if the token is issued by an entity associated with a visited network, the mobile may send the token to the PSAN to indicate agreement to service-based local policy (SBLP) enforcement of bearer services at the packet-based access network level in the visited network. Transmission of an SBLP-implemented indication token by a node in the PSAN to the charging node permits the charging node to take that fact into account in the session charge. For example, the session charge may be discounted because the mobile user agreed to SBLP.

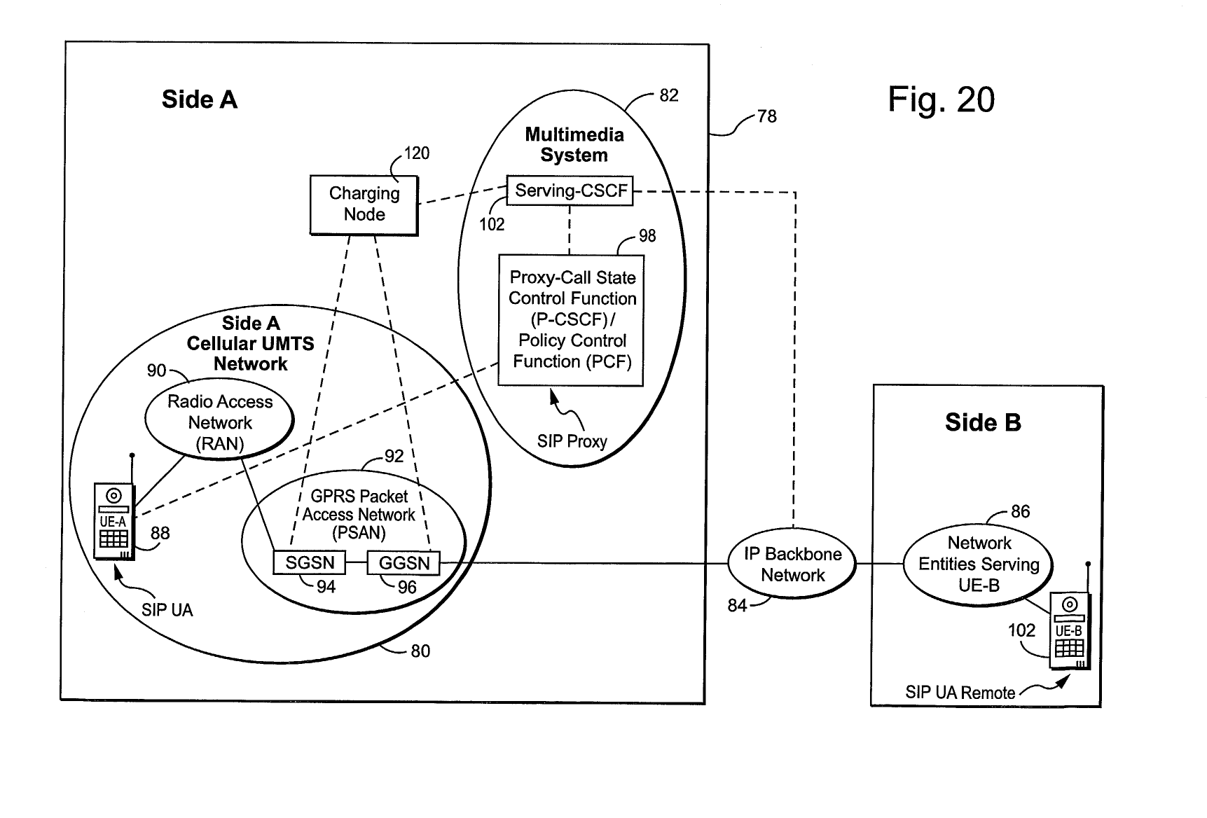

The present invention has particularly advantageous example application to multimedia sessions involving a GPRS/UMTS network. Of course, the present invention is not limited to this particular example application or to the example embodiment now described. Reference is made to the communications system shown in FIG. 20. A mobile terminal 88 is referred to in FIG. 20 as User Equipment-A (UE-A). In the context of session level signaling, e.g., the session initiation protocol (SIP), the UE-A is a SIP user agent. UE-A 88 is part of a “side A” 78 of the session and is coupled to a radio access network (RAN) 90. The RAN 90 is coupled to a GPRS network 92 which includes a serving GPRS support node (SGSN) 94 coupled to a gateway GPRS support node (GGSN) 96. The UE-A 88 desires to establish a multimedia session with a remote host 122 corresponding to UE-B which is also a SIP user agent referred to a SIP UA Remote. The solid lines in FIG. 20 show the packet data path between UE-A and UE-B in the multimedia session via the RAN 90, the SGSN 94, the GGSN 96, the IP backbone network 84, and similar RAN and GPRS entities serving UE-B represented by the side-B “bubble” 86. The dashed lines illustrate session control and charging signaling. The bubble 86 in side B also includes a multimedia system and charging node similar to what is shown for side A.

A service charging identifier in accordance with the invention is generated for a session, and it is used by a charging entity to correlate charging-related information for the session. The term service charging identifier (SCI) may encompass more than one type of charging identifier and may be generated by different entities. Typically, the SCI is generated by the S-CSCF, which is the home operator that is providing and coordinating services for the multimedia session requested by UE-A. Alternatively, the service charging identifier may be generated by the proxy-CSCF. If the UE accepts SBLP in the visited network by sending the P-CSCF-generated SCI, the GGSN may send an SBLP implemented indicator to the charging node. Recall also that the UE, the charging node, or other entities may issue an SCI related to the multimedia session.

If the service charging identifier is issued by the S-CSCF during session setup (using for example SIP signaling) to allow coordination of charging at the SIP session level and GPRS bearer level, such a service charging identifier is termed a “Home Operator Charging Identifier” (HOCI) for ease of description. The HOCI is issued by the S-CSCF when the home operator, who owns the multimedia service(s), allows service-bearer bundling of charging for a multimedia session. The HOCI is passed from the S-CSCF 102 via the P-CSCF/Policy Control Function (PCF) 98 to the UE 88 during session setup to permit coordination of charging at both the session level and the bearer level by the charging node 120 when it receives charging related messages including the HOCI. On the other hand, if the HOCI is not issued by the S-CSCF, e.g., the home network operator does not allow service-bearer bundling for service charging, charges are not correlated between the SIP session and the GPRS bearer level. Session charging and bearer charging are carried out independently.

From the perspective of the UE, the HOCI may correspond to certain advantages and/or discounts associated with bundled session-bearer charging. However, to participate in such advantages and/or discounts, the UE may have to agree to bundled charging or to some service level contract with the home operator. More specifically, if the UE sends the HOCI during PDP context activation/modification with the GGSN and the SGSN, this may be interpreted as an agreement to such condition. Upon receipt of the HOCI, the GGSN includes the HOCI in the PDP context activation/modification response message using the PDP configuration options (PCO) parameter. The SGSN may send the HOCI to the charging node 120 before the session for a pre-paid service or in real time via the GSM CAMEL interface (Ge) or off-line using call data records (CDRs) sent by the GSM Ga interface.

The charging node 120 may correspond to a home operator cost control node. As discussed above, receipt of the HOCI from the SGSN for the multimedia session may be interpreted as agreement to one or more charging arrangements including: (1) agreement to bundle charging at the session and GPRS bearer levels, (2) discounts of bearers and/or services with the home and any visited operator depending on roaming/business agreements between the home and visited networks, (3) SBLP charging arrangements, etc. On the other hand, if the HOCI is not received, traditional charging mechanisms such as those employed in current GPRS networks may be applied.

If a HOCI is issued per multimedia session, the UE and the S-CSCF may both generate a media stream-specific HOCI using a predetermined procedure, such as the examples described in the two co-pending U.S. patent applications referenced above. The media stream-specific HOCIs are submitted by the UE to the GGSN during PDP context activation/modification to permit correlation of each specific media stream in the session with its corresponding GPRS bearer. In addition, the PDP configuration options (PCO) parameter in PDP context activation/modification messages may be used to carry a HOCI, a media stream-specific HOCI, or a network-specific HOCI to the GGSN. The network-specific HOCI may be generated by a network node such as the GGSN in the GPRS Network along with the S-CSCF.

The proxy-CSCF may issue the SCI during SIP session setup to allow coordination of charging at a SIP session level and a GPRS bearer level. The P-CSCF issued SCI may be provided to the charging node via the S-CSCF. In addition to certain advantages and discounts associated with bundled session-bearer charging described above for the HOCI, if the service charging identifier is issued by the visited network P-CSCF, it may be used by the UE to indicate whether the UE agrees to be subjected to service-based policy (SBLP) control by the visited network operator. The UE may submit the P-CSCF-issued service charging identifier during PDP context activation/modification. Sending this SCI indicates the UE's agreement to SBLP, and the GGSN performs service-based policy control on the GPRS bearers supporting the session.

The GGSN, upon receipt of the service charging identifier from the UE, includes a “SBLP-implemented” indication or token (different from the SCI) in the PDP context activation/modification response message to the SGSN using, for example, the PDP configuration options parameter. The SGSN may then forward that SBLP-implemented indication in a real time charging message to the charging node 120. Alternatively or in addition, off-line CDRs may be sent to the charging node with the SBLP-implemented indication by the SGSN or the GGSN. The charging node 120 recognizes the SBLP-implemented indication as an agreement by the UE to service-based local policy enforcement of the GPRS bearers by the visited or serving network operator. As a result, the charging node may apply a discounted rate for SBLP-controlled bearers, depending on roaming agreements between home and visited networks, as an incentive to the UE to agree to SBLP.

Charging messages sent from different entities may contain different types of charging information related to the multimedia session. A charging message from the serving-CSCF containing the service charging identifier may relate to the nature of the call (e.g., voice, video, e-mail, etc.) and the duration. A charging message generated by the SGSN or GGSN may relate to the volume of data sent during the call and whether the UE agreed to SBLP in the visited network.

Reference is now made to flowchart routines illustrating example procedures relating to various aspects of the present invention as applied to the example environment illustrated in FIG. 20. FIG. 21 illustrates a multimedia Session Charging-GPRS Access procedures (block 130). The multimedia session is initiated using SIP signaling (block 132), and a service charging identifier (SCI) is provided to an IP-based Multimedia System (IMS) entity and to a GPRS entity (block 134). Again, the service charging identifier may be a session identifier or it may be specific to each media stream or to a GPRS/IMS entity. The charging node 120 receives charging messages from the IMS and GPRS entities, including the service charging identifier (SCI), and uses the SCI to correlate those charges related to services provided in the IMS and the GPRS network for the multimedia session (block 136).

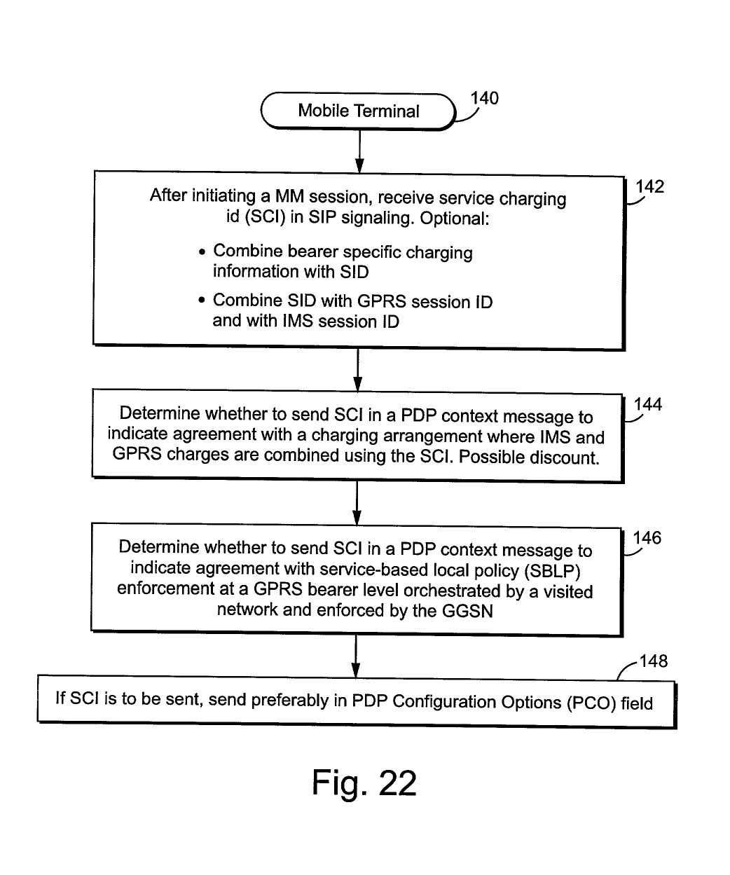

FIG. 22 illustrates example procedures that may be implemented in the Mobile Terminal with respect to certain aspects of the present invention (block 140). After initiating the multimedia session, the mobile terminal receives a service charging identifier (SCI) in SIP signaling from a CSCF entity (the SCI maybe generated by the S-CSCF, P-CSCF, or alternatively, the charging entity). As indicated, there are multiple options for generating the SCI. The SCI may be simply assigned to identify the session, it may be specific to each bearer by combining a session identifier with media-specific information, or it may be made specific to one of the GPRS or IMS entities. In addition, the mobile terminal may optionally determine whether to send the SCI in a PDP context message to indicate agreement with a charging arrangement where IMS and GPRS charges are combined using the SCI for the session. As described above, such arrangements may also include possible discount and other service contract arrangements (block 144). In another optional embodiment, the mobile may determine whether to send the SCI in a PDP context message to indicate agreement with service-based local policy (SBLP) enforcement at a GPRS bearer level by the GGSN (block 146). In such an SBLP case, the SCI is supplied by the proxy-CSCF. In the event the SCI is sent by the UE, it is sent preferably in a PDP configurations option (PCO) field of the PDP context message (block 148).

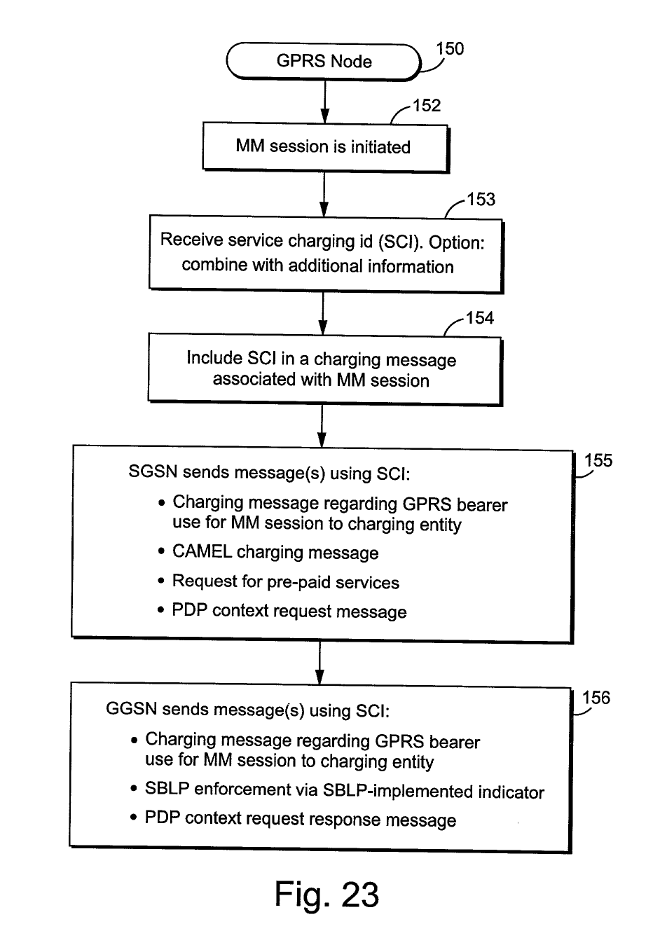

Example procedures that may be used for implementing certain aspects of the invention at a GPRS Node (block 150) are now described in the context of a flowchart illustrated in FIG. 23. After the multimedia session is initiated (block 152), a node in the GPRS network receives a service charging identifier (SCI) (generated either by the S-CSCF, P-CSCF, or charging node) from the mobile terminal (block 153). There is an option, as described above, for combining the service charging identifier with additional information that is either bearer-specific or network-specific. The SCI is included in a charging message associated with the multimedia session sent by the GPRS node to the charging node (block 154).

In one example embodiment, the GPRS node may be the SGSN which sends one or more charging messages to the charging entity 120. Such a charging message could be a CAMEL charging message and may be sent in advance of service use as, for example, in a prepaid service environment, in real time, or off-line. The SGSN includes the SCI in the PDP context request message sent to the GGSN in the GPRS network (block 155). If the GPRS node corresponds to the GGSN, the SCI may be included in a charging message regarding GPRS bearer use for the multimedia session sent to the charging node 120 (block 156). The GGSN includes the SCI in the PDP context response message sent to the SGSN. In addition, if the sending of the SCI by the mobile terminal indicates agreement to service-based local policy, the GGSN may send an SBLP-implemented indicator to the charging node to indicate that SBLP enforcement applies for this session.

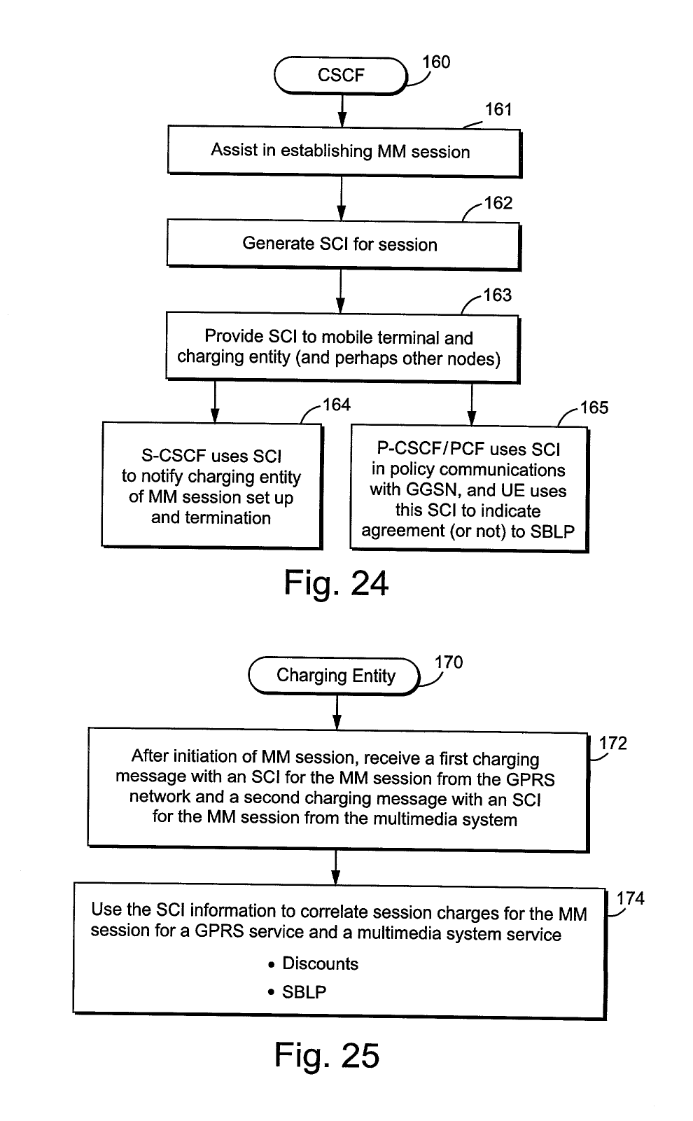

Reference is now made to FIG. 24 which illustrates example flowchart procedures that may be implemented by a Call State Control Function (CSCF) entity (block 160). The CSCF assists in establishing the multimedia session (block 161) and also may generate a service charging identifier for the multimedia session (block 162). The CSCF entity provides the SCI to the mobile terminal, to the charging entity, and perhaps to other nodes, such as the GGSN or SGSN, to permit correlation of charging messages by the charging entity for bearer level and session level services associated with a multimedia session (block 163). If the CSCF is a serving-CSCF, the SCI may be used to notify the charging entity of the multimedia session setup and termination (block 164). If the CSCF entity is a proxy-CSCF/PCF, the SCI generated may be used as a SBLP-token (as well as a service charging identifier) by the UE to indicate agreement with SBLP in the visited network as described above (block 165).

Reference is now made to the flowchart diagram illustrated in FIG. 25 setting forth example procedures relating to certain aspects of the present invention related to the Charging Entity (block 170). During initiation of a multimedia session, the charging entity may receive a may receive a service charging indicator (SCI) for the multimedia session from the S-CSCF or from the P-CSCF (e.g., via the S-CSCF). After sesssion initiation, the charging entity may receive a first charging message with the service charging indicator for the multimedia session from the GPRS network and a second charging message with the SCI for the multimedia session from the multimedia system (block 172). The charging entity uses the SCI information to correlate the session charges for the multimedia session for one or more GPRS bearer services and one or more multimedia system services. The charging entity may also use receipt of the SCI to apply certain charging discounts for this multimedia session (block 174). For SBLP, an ‘SBLP-implemented indication’ may be received from the GGSN (either via CAMEL interface or off line CDR's).

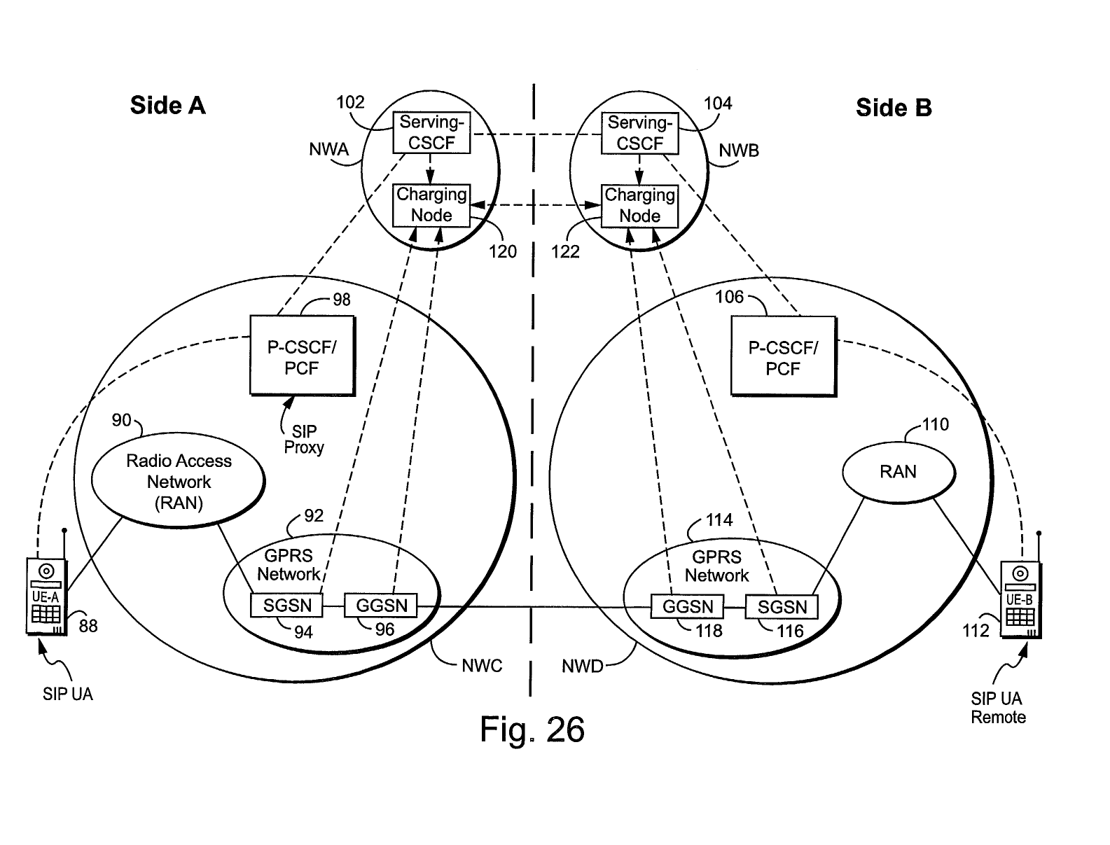

FIG. 26 shows a communications system with several different networks NWA-NWD each operated by different operators using like reference numerals from FIG. 20 (although the IP backbone network is not shown). The network NWA is UE-A's home network, and for purposes of the multimedia session between UE-A and UE-B, only the serving-CSCF 102 and a charging node 120 are shown. The network NWC is the network currently being visited by UE-A, and includes a proxy-CSCF/PCF 98. The P-CSCF/PCF 98 communicates with the serving-PSCF 102 and corresponds to a “SIP proxy” for the SIP user agent UE-A 88. The networks NWA and NWC along with UE-A 88 make up the “side-A” for the session.

The side-A charging node 120 may receive information from one or more of the SGSN 94, GGSN 96, the proxy-CSCF/PCF 98, and/or the serving-CSCF 102. The charging node 120 may be coupled to a billing system (not shown) and may be any type of charging entity configured to correlate charges for a multimedia session from multiple sources and levels using a service charging identifier included in each charging message.

The serving-CSCF provides charging node 120 with session level charges related to the multimedia session established between UE-A and UE-B using a service charging identifier (SCI). It is the home network NWA that is responsible for providing the services for the multimedia session initiated by UE-A. Such a charging message from the S-CSCF 102 may be sent, for example, formatted as a DIAMETER message.

In addition, GPRS bearer level services associated with the multimedia session may be provided by the SGSN 94 to the charging node 120 in charging messages that include the service charging identifier. The SGSN 94 may send charging related messages in real time to the charging node 120 as CDRs over the GSM “Ga” interface or as CAMEL based messages over the GSM/CAMEL “Ge” interface. Using the service charging identifier, the charging node 120 correlates the charges for different types of services and at different levels to combine them into a single charge for the multimedia session.

For sessions in which service-based local policy (SBLP) is offered by the visiting network NWC, the P-CSCF 98 may generate an SBLP-related a service charging identifier. The P-CSCF/PCF 98 communicates it to the charging node 120 and to the UE-A. If the UE-A agrees to SBLP in the visited network for the session, e.g., in exchange for a discounted charging rate for the session, it sends the SBLP SCI to the GGSN 96. A message from the GGSN 96 to the charging node 120 includes an SBLP-implemented indicator (different from the SCI) which may be used by the charging node 120 to determine charging for the session. The charging node uses the SBLP-implemented indicator to correlate the SBLP-related charging information with the session. The GGSN 96 may send SBLP charging messages off-line as one or more CDRs.

The network entities for side-B of the session mirror those described for side-A. The home network for UE-B 112 is network NWB which includes a serving-CSCSF 104 and a charging node 122. UE-B 112 is currently coupled to a visiting network NWD via RAN 110. The RAN 110 is coupled to a GPRS network 114 that includes an SGSN 116 coupled to a GGSN 118. Session traffic between UE-A and UE-B travels along the path defined by RAN 90, SGSN 94, GGSN 96, an IP backbone network (not shown), GGSN 118, SGSN 116, and RAN 110. The visited network includes a P-CSCF/PCF 106. The P-CSCF/PCF 106 is coupled to the S-CSCF 104.

The side-B charging node 122 may receive information from one or more of the SGSN 116, GGSN 118, the proxy-CSCF 106, and/or the serving-CSCF 104. The charging node 122 may be coupled to a billing system (not shown) and may be any type of charging entity configured to correlate charges for a multimedia session from multiple sources using a service charging identifier included in each charging message. The two charging nodes 120 and 122 communicate charging information regarding the session using the same service charging identifier. If there is only one charging node for the session, then all of the charging messages for the session from the side A and side B would be communicated to that charging node.

Although the description has focused on the token being sent to the mobile terminal, in another example embodiment where a calling party A has a session connected to a called party B, a common service charging identifier (token) is passed on to the packet-switched access networks and multimedia systems of both A side and B side. The common service charging identifier is used by a charging node of both sides to correlate the charges from both A and B sides. The common SCI facilitates the “A-party pays” charging model, where the originating side party A pays for the cost of the entire session just like what is available today in GSM when the terminating B-party is not roaming. Alternatively, both sides can use different/independent service charging identifiers, and the correlation of the two service charging identifiers is carried out via communication between the two charging nodes. This way the service charging identifier need not be “global” in nature which is more difficult to handle/standardize.

Furthermore, both side A and side B may use different/independent service charging identifiers, and the correlation of the two service charging identifiers is carried out via communication between the two charging nodes. This approach eliminates the need for a global SCI identifier, which might be more difficult to handle/standardize than a different SCI per side. Each side's SCI should be unique per session for one user. One way to construct these different SCIs is to combine a session identifier with UE-A identifier, (e.g., UE-A's IMSI), and the same session identifier with UE-B's identifier. As described above, the UE may add a flow identifier to differentiate between the media flows in the session. Each side's SCI may preferrably be “encrypted” (not predictable) to ensure that there is no tampering with the SCIs in an effort to avoid session charges or obtain cheaper session charges.

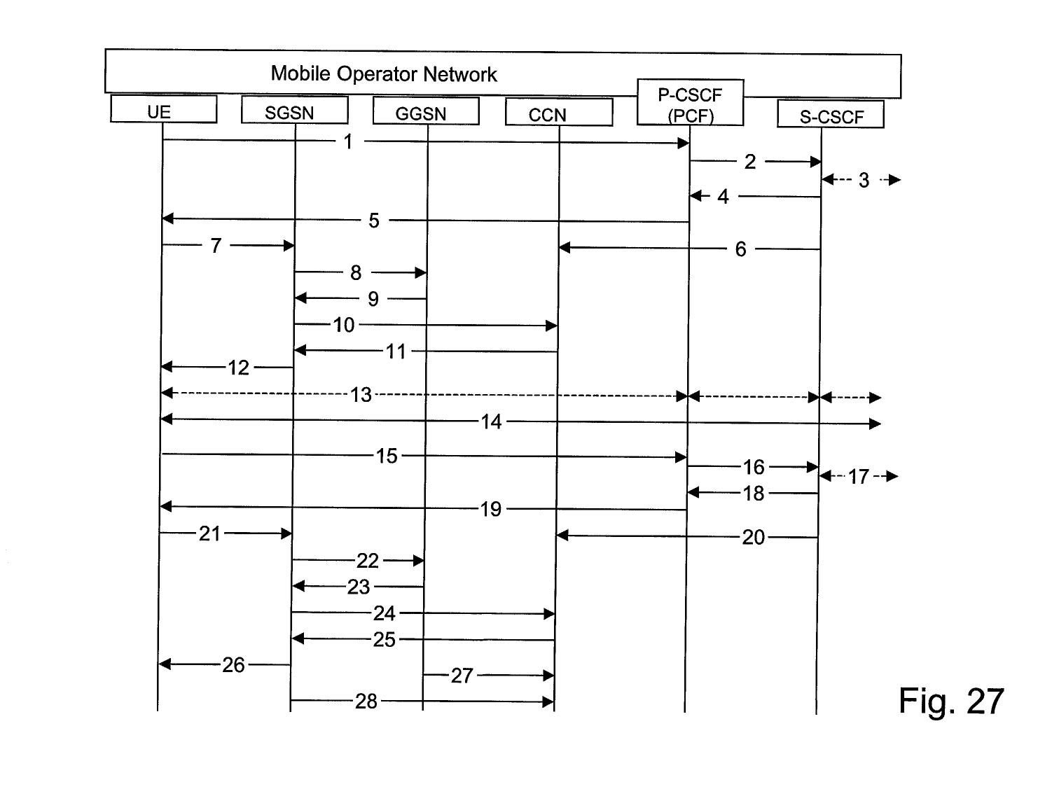

FIG. 27 provides an example signaling diagram for a multimedia session where the SCI includes a high level HOCI without any media-specific or GPRS/IMS specific information. Each signal is described briefly below by number.

1-2. SIP INVITE message from UE to P-CSCF/PCF, forwarded to S-CSCF.

3. SIP INVITE message propagated further until intended destination, (e.g., remote host). SIP 183 message comes back.

4. S-CSCF generates HOCI and includes it in SIP 183 to P-CSCF/PCF.

5. P-CSCF/PCF forwards SIP 183 with HOCI to UE.

6. S-CSCF notifies CCN of the setup of session with HOCI as common identifier.

7. UE activates PDP context, includes HOCI in PDP context message.

8. SGCN forwards PDP context request with HOCI to GGSN. Before this is done, the SGSN may also communicate with the CCN in order to check whether there is sufficient money in the prepaid account. This is also the point in time when the HOCI may be sent to the CCN in order for the CCN to decide the appropriate charging rate.

9. GGSN responds to PDP context request, includes HOCI in message.

10. SGSN forwards HOCI in CAMEL message to charging node CCN to start pre-paid/hot billing services. This step may be omitted if this was done earlier in step 8.

11. CCN confirms receipt of HOCI.

12. SGSN completes PDP context activation and responds to UE.

13. The rest of SIP interactions continue which completes the session setup.

14. Media starts flowing from UE to remote destination.

15. The UE decides to terminate the session. SIP “Bye” message is sent to P-CSCF/PCF.

16-18. SIP “Bye” propagated further until intended destination, SIP OK message comes back.

19. P-CSCF/PCF forwards SIP OK to UE.

20. S-CSCF notifies CCN of the termination of session with HOCI as common identifier.

21-22. UE deactivates PDP context, request propagated to GGSN.

23. GGSN responds to PDP deactivation request.

24. SGSN notifies CCN of deactivation of PDP context, using HOCI as common identifier.

25. CCN confirms deactivation of PDP context.

26. PDP deactivation successfully propagated to UE.

27-28. The GGSN and SGSN forward CDRs to CCN, using the HOCI as identifier.

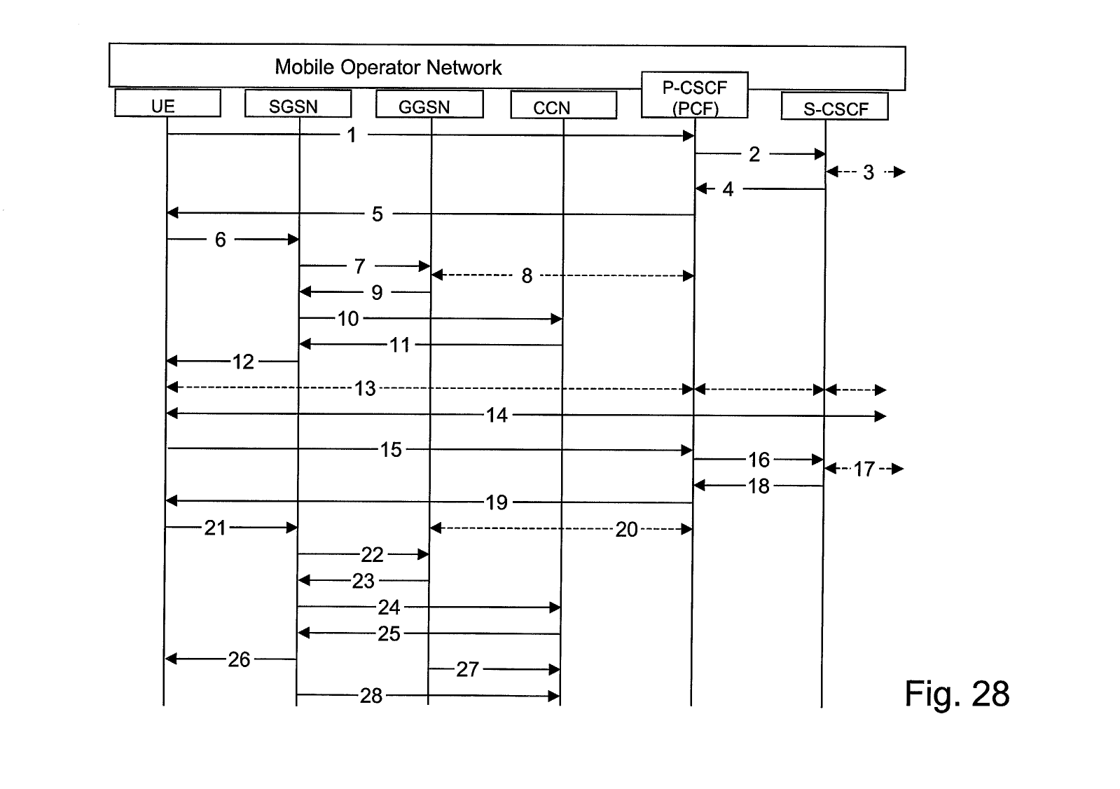

FIG. 28 illustrates an example signaling flow where the service charging identifier includes SBLP information. The numbered signal flows are explained below.

1-2. SIP INVITE message from UE to P-CSCF/PCF, forwarded to S-CSCF.

3-4. SIP INVITE message propagated further until intended destination, (e.g., remote host). SIP 183 message comes back.

5. P-CSCF/PCF generates SBLP SCI, and includes it in SIP 183 to UE.

6. UE activates PDP context, includes SBLP SCI in PDP context message.

7. SGSN forwards PDP context request with SBLP SCI to GGSN.

8. SBLP-related exchanges with GGSN take place, using SBLP SCI as identifier. SBLP implemented in GGSN.

9. GGSN responds to PDP context request, includes ‘SBLP implemented’ indication

10. GGSN forwards ‘SBLP implemented’ indication in CAMEL message to CNN to start pre-paid/hot billing services.

11. CCN confirms receipt of ‘SBLP implemented’ indication.

12. SGSN completes PDP context activation and responds to UE.

13. The rest of SIP interactions continue which completes the session setup.

14. Media starts flowing from UE to remote destination.

15. The UE decides to terminate the session. SIP “Bye” is sent to P-CSCF/PCF.

16-19. SIP “Bye” propagated further until intended destination, SIP OK comes back to UE.

20. SBLP-exchanges with GGSN take place to de-authorize the use of bearers.

21-23. UE deactivates PDP context, request propagated to GGSN, GGSN responds to PDP deactivation request.

24. SCSN notifies CCN of deactivation of PDP context.

25. CCN confirms deactivation of PDP context.

26. PDP deactivation successfully propagated to UE.

27-28. The GGSN and SGSN forward CDRs to CCN, with the ‘SBLP implemented’ indication.

While the present invention has been described with respect to particular embodiments, those skilled in the art will recognize that the present invention is not limited to these specific exemplary embodiments. Different formats, embodiments, and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A method for charging for a multimedia session established between a mobile terminal and a remote host, comprising:
establishing the multimedia session between the mobile terminal and the remote host over a radio access network via a packet-switched access network coupled to a multimedia system, having one or more multimedia servers for providing multimedia services for multimedia sessions;
generating a token associated with the multimedia session; and
using the token, correlating session charges for a first operation performed in the packet-switched access network associated with the multimedia session and for a second operation performed in the multimedia system associated with the multimedia session.

2. The method in claim 1, further comprising:
a first entity in the packet-switched access network including the token in a first charging message associated with the session sent to a charging entity; and
a second entity in the multimedia system including the token in a second charging message associated with the session sent to the charging entity,
wherein the charging entity performs the correlating step.

3. The method in claim 2, wherein the first and second charging messages correspond to first and second call data records.

4. The method in claim 2, wherein the first charging message includes information related to bearer services used in the packet-switched access network for the session.

5. The method in claim 4, wherein the information includes access bearer-specific charging information for one or more access bearers used in the session.

6. The method in claim 5, wherein the information includes one or more of the following: location of the mobile terminal, location of the remote host, volume of packets sent or received, time, and quality of service parameters associated with one or more of the packet access bearers used in the session.

7. The method in claim 2, wherein the second charging message includes information related to services used in the multimedia system for the session.

8. The method in claim 7, wherein the information includes one or more of the following: type of multimedia service, identity of originating and terminating entities, service based local policy restrictions, discounted charging scenarios, and amount of time in which session resources are used.

9. The method in claim 2, wherein the token includes a session identifier, the method further comprising:
sending in the first charging message the session identifier and an access network charging identity for the session to the charging entity, and
sending in the second charging message the session identifier and a multimedia system charging identity for the session to the charging entity,
wherein the charging node uses the session identifier and charging identities in the first and second charging messages to generate a charge for the session.

10. The method in claim 1, further comprising:
using the token to indicate whether a charging discount applies to the session.

11. The method in claim 1, wherein the token is generated by an entity in the multimedia system, the method further comprising:
sending the token from the entity to the mobile terminal.

12. The method in claim 11, wherein if the mobile terminal sends the token to the packet-switched access network, the mobile terminal indicates agreement to charging for the multimedia session where bearer level and session level services for the session are combined.

13. The method in claim 12, wherein if the mobile terminal does not send the token to the packet-switched access network, the mobile terminal indicates a decision not to agree to charging for the multimedia session where bearer level and session level services for the session are combined.

14. The method in claim 11, wherein the entity is associated with a home network operator of the mobile terminal, and wherein by sending the token to the packet-switched access network, the mobile terminal indicates agreement to a service level contract with the home network operator.

15. The method in claim 11, wherein the entity is associated with a visited network, and wherein by sending the token to the packet-switched access network, the mobile terminal indicates agreement to service-based local policy (SBLP) enforcement of bearer services at the packet-based access network level in the visited network.

16. The method in claim 1, wherein the first operation is a bearer level service related to transporting each media stream in the session through the packet-switched access network.

17. The method in claim 1, wherein the second operation is a session level service relating to setting up or controlling multimedia services requested for the session.

18. The method in claim 1, wherein if the token is not used, bearer level and session level services associated with the session are charged for separately.

19. The method in claim 1, wherein the token includes a session identifier, the method further comprising:
generating a complete token for each media data stream using the session identifier and a media stream identifier corresponding to that media data stream,
wherein the complete token is used to correlate bearer level charges for each media data stream with session level charges for each media data stream.

20. The method in claim 1, wherein the token is encrypted.

21. The method in claim 1, wherein the token is sent to the mobile terminal and the remote host.

22. The method in claim 1, further comprising:
generating first and second different tokens associated with the multimedia session, the first token being associated with the mobile terminal and the second token being associated with the remote host.

23. The method in claim 22, further comprising:
using the first and second tokens, correlating session charges.

24. The method in claim 1, further comprising:
using the token to correlate the charges in the multimedia session in an A-party pays charging model.

25. A method for use in charging for a multimedia session between a mobile terminal and a remote host, comprising:
using session level signaling, initiating a multimedia session with plural media data streams between the mobile terminal and a remote host coupled to the mobile terminal being coupled to an IP-based multimedia system (IMS) that provides multimedia session services by way of a General Packet Radio Service (GPRS) network;
generating a service charging identifier corresponding to the session, and
correlating charges related to operations performed in the IMS and the GPRS network associated with the session using the service charging identifier.

26. The method in claim 25, wherein a call service control function (CSCF) entity in the IMS generates the service charging identifier and sends it to the mobile terminal.

27. The method in claim 26, wherein the CSCF entity is a serving-CSCF entity (S-CSCF) associated with a home network for the mobile terminal.

28. The method in claim 27, wherein if the mobile terminal sends the service charging identifier to the GPRS network, the mobile terminal indicates agreement to combined charging of both bearer level and session level services for the multimedia session.

29. The method in claim 28, wherein if the mobile terminal does not send the token to the GPRS network, the mobile terminal indicates a decision not to agree to the combined charging for the multimedia session.

30. The method in claim 28, wherein by sending the service charging identifier to the GPRS network, the mobile terminal indicates agreement to a service level contract with a home network operator of the mobile terminal.

31. The method in claim 26, wherein the CSCF entity is a proxy-CSCF entity (P-CSCF) associated with a network visited by the mobile terminal.

32. The method in claim 31, wherein by sending the service charging identifier to the GPRS network, the mobile terminal indicates agreement to service-based local policy (SBLP) enforcement of bearer services at the GPRS network level based on policy information for the session provided by the P-CSCF/PCF to a gate keeper node in the GPRS network.

33. The method in claim 32, wherein the gatekeeper includes an SBLP-implemented indicator in a charging message related to the multimedia session sent to a charging node.

34. The method in claim 26, wherein the mobile terminal includes the service charging identifier in a packet data protocol (PDP) context message sent to a node in the GPRS network.

35. The method in claim 34, wherein the service charging identifier is included in a PDP configuration options (PCO) field.

36. The method in claim 34, wherein the GPRS node is a serving GPRS support node (SGSN).

37. The method in claim 36, wherein the SGSN sends the service charging identifier with charging information to a home network cost control node.

38. The method in claim 36, wherein the home network cost control node performs real time charging or prepaid charging.

39. The method in claim 36, wherein the SGSN sends the service charging identifier with charging information over a CAMEL interface in real time or before the session begins.

40. The method in claim 36, wherein the SGSN sends the service charging identifier with charging information in a call data record (CDR) to charging node after the session ends.

41. The method in claim 34, wherein a gateway GPRS support node (GGSN) sends the service charging identifier in a PDP context response message or with charging information via a CDR for off-line charging to a charging node.

42. The method in claim 34, wherein if the mobile terminal agrees to service based local policy enforcement, the GGSN sends a SBLP-implemented indication in a PDP context response message or with charging information via a CDR for off-line charging to a charging node

43. The method in claim 26, further comprising:
a GPRS entity including the service charging identifier in a first charging message associated with the session to a charging entity; and
an IMS entity including the service charging identifier in a second charging message associated with the session to the charging entity,
wherein the charging entity performs the correlating step.

44. The method in claim 43, wherein the first and second charging messages correspond to first and second call data records.

45. The method in claim 43, wherein the first charging message corresponds to a CAMEL charging message and the second charging message corresponds to a DIAMETER charging message.

46. The method in claim 43, wherein the first charging message includes information related to GPRS bearer services used in the GPRS network for the session.

47. The method in claim 46, wherein the information includes GPRS bearer-specific charging information for one or more GPRS bearers used in the session.

48. The method in claim 47, wherein the information includes one or more of the following: location of the mobile terminal, location of the remote host, volume of packets sent or received, a quality of service parameter, and time, associated with one or more of the GPRS bearers used in the session.

49. The method in claim 43, wherein the second charging message includes information related to services used in the IMS for the session.

50. The method in claim 49, wherein the information includes one or more of the following: type of multimedia level service used, identity of originating and terminal entities, service based local policy restrictions, discounted charging scenarios, and amount of time in which session resources are used.

51. The method in claim 43, further comprising:
sending in the first charging message the service charging identifier and a GPRS network charging identity for the session to the charging entity,
sending in the second charging message the service charging identifier and an IMS charging identity for the session to the charging entity,
wherein the charging entity uses the service charging identifier and the GPRS and IMS charging identities to generate a charge for the session.

52. The method in claim 43, further comprising:
using the service charging identifier to indicate to the charging entity whether a charging discount applies to the session.

53. For use in setting up a multimedia session between the mobile terminal and a remote host using session signaling, where the multimedia session includes plural media data streams, the mobile terminal being coupled to a multimedia system that provides multimedia session services, the mobile terminal comprising electronic circuitry configured to perform the following tasks:
initiate the multimedia session using session signaling so that a plurality of media packet access bearers can be established over a packet-switched access network to transport corresponding ones of the media data streams between the mobile terminal and the access point;
receive a service charging identifier;
determining whether to send the service charging identifier in a packet context message to be sent to the packet-switched access network,
wherein sending the service charging identifier in the packet context message indicates an agreement by the mobile terminal to a charging arrangement that correlates session charges associated with the multimedia session, and wherein not sending the session charging identifier in the packet context message indicates that the mobile terminal does not agree to the charging arrangement.

54. The mobile terminal in claim 53, wherein the session charges include charges for a first operation performed by the packet-switched access network and for a second operation performed by the multimedia system

55. The mobile terminal claim 54, wherein the electronic circuitry is configured to indicate agreement to a discount charging arrangement for a combined charge for the first and second operation by sending the service charging identifier in the packet context message.

56. The mobile terminal claim 54, wherein the electronic circuitry is configured to indicate agreement to service-based local policy enforcement at an access bearer level orchestrated by a visiting network and enforced by a gate keeper node in the packet-switched access network by sending the service charging identifier in the packet context message.

57. The mobile terminal in claim 54, wherein the packet-switched access network is a GPRS network and the multimedia system is an IP-based multimedia system (IMS) that provides multimedia session services by way of GPRS bearers, and wherein the packet context message is a PDP context activation message.

58. The mobile terminal in claim 57, wherein the service charging identifier is included in a PDP configuration options (PCO) field in the PDP context activation message.

59. The mobile terminal in claim 54, wherein the electronic circuitry is configured to combine the service charging identifier with a media stream identifier.

60. A node in a packet-switched access network coupled to a radio access network and to a multimedia system for providing services in a multimedia session between a mobile terminal and a remote host, where in response to a multimedia session request from the mobile terminal, a multimedia session is established involving the mobile terminal that includes a plurality of media data streams including establishing a plurality of media packet access bearers between the mobile terminal and the access point, the media packet access bearers transporting corresponding ones of the media data streams over the packet-switched access network, comprising electronic circuitry configured to perform the following tasks:
receive a service charging identifier;
include the service charging identifier in a charging message associated with the multimedia session; and
send the service charging message with the session charging identifier to a charging entity.

61. The packet-switched access network node in claim 60, wherein the electronic circuitry is configured to combine the service charging identifier with additional information.

62. The packet-switched access network node in claim 61, wherein the additional information includes a network identifier associated with the multimedia session.

63. The packet-switched access network node in claim 60, wherein the packet-switched access network is a GPRS network and the packet-switched access network node is an SGSN, the electronic circuitry in the SGSN being configured to:
receive a PDP context message from the mobile terminal which includes the service charging identifier, and
forward the service charging identifier in a PDP context request message to a GGSN.

64. The packet-switched access network node in claim 60, wherein the packet-switched access network is a GPRS network and the packet-switched access network node is an SGSN, the electronic circuitry in the SGSN being configured to:
receive a PDP context message from the mobile terminal which includes the service charging identifier, and
forward the service charging identifier to the charging entity in a charging message.

65. The packet-switched access network node in claim 64, wherein the charging message is a CAMEL message sent in real time.

66. The packet-switched access network node in claim 64, wherein the charging message is a request for pre-paid services associated with the multimedia session.

67. The packet-switched access network node in claim 60, wherein the packet-switched access network is a GPRS network and the packet-switched access network node is an GGSN, the electronic circuitry in the GGSN being configured to:
receive a PDP context request message which includes the service charging identifier, and
respond to the PDP context request message including the service charging identifier.

68. The packet-switched access network node in claim 60, wherein the packet-switched access network is a GPRS network and the packet-switched access network node is an GGSN, the electronic circuitry in the GGSN being configured to:
implement service-based local policy for the multimedia session using the service charging identifier, and
send a charging message indicating implementation of the service-based local policy for the multimedia session.

69. The packet-switched access network node in claim 60, wherein the packet-switched access network is a GPRS network and the packet-switched access network node is an GGSN, the electronic circuitry in the GGSN being configured to send a charging message to a charging entity associated with the multimedia session and including the service charging identifier so that the charging entity may correlate GPRS bearer level service charges with session level charges for the multimedia session.

70. For use in setting up a multimedia session between a mobile terminal and a remote host using session signaling, where the multimedia session includes plural media data streams, the mobile terminal being coupled to packet-switched access network and to a multimedia system that provides multimedia session services, a multimedia service controller comprising:
electronic circuitry configured to provide to the mobile terminal and to a charging entity a service charging identifier associated with the multimedia session,
wherein the charging entity uses the service charging identifier to correlate session charges associated with the multimedia session for a packet-switched access network service and for a multimedia system service.

71. The multimedia service controller in claim 70, wherein the packet-switched access network service is a bearer level service and the multimedia system service is a session level service.

72. The multimedia service controller in claim 70, wherein the multimedia service controller is a serving-multimedia service controller associated with a home network operator of the mobile terminal.

73. The multimedia service controller in claim 72, wherein the serving-multimedia service controller uses the service charging identifier to notify the charging entity of the set up and termination of the multimedia session.

74. The multimedia service controller in claim 70, wherein the multimedia service controller is a proxy-multimedia service controller associated with a network visited by the mobile terminal.

75. The multimedia service controller in claim 74, wherein the proxy-multimedia service controller uses the service charging identifier in policy related communications with a policy control function in the multimedia system and a gate keeper in the packet-switched access network.

76. For use in a multimedia session between a mobile terminal and a remote host using session signaling, where the multimedia session includes plural media data streams, the mobile terminal being coupled to packet-switched access network and to a multimedia system that provides multimedia session services, a charging controller comprising electronic circuitry configured to perform the following tasks:
receive a first charging message with a service charging identifier associated with the multimedia session from the packet-switched access network;
receive a second charging message with the service charging identifier from the multimedia system; and
use the service charging identifier to correlate session charges associated with the multimedia session for a packet-switched access network service and for a multimedia system service.

77. The charging controller in claim 76, wherein the first and second charging messages are call data records.

78. The charging controller in claim 76, wherein the first charging message is a CAMEL message and the second charging message is a DIAMETER message.

79. The charging controller in claim 76, wherein the electronic circuitry is configured to generate a combined service charge for the multimedia session that combines charges for the packet-switched access network service and the multimedia system service into one charge for the session.

80. The charging controller in claim 79, wherein the electronic circuitry is configured to provide discounted charges for the session when the mobile terminal agrees to combined charges.

81. The charging controller in claim 79, wherein the electronic circuitry is configured to provide discounted charges for the session when the mobile terminal agrees to a service contract associated with a home network of the mobile terminal.

82. The charging controller in claim 79, wherein the electronic circuitry is configured to account for a service based local policy implemented message received from the packet switched access network in a session charge.

83. The charging controller in claim 79, wherein the service identifier identifies the multimedia session and the one of the packet-switched access network and the multimedia system entity that sent the first or second charging message, respectively.

84. The charging controller in claim 76, wherein the service charging identifier is used to correlate session charges for an A-party pays charging model.

85. The charging controller in claim 76, wherein an A-side of the session includes the mobile terminal, the packet-switched access network, the multimedia system, and the charging controller, and a B-side of the session includes similar entities, wherein an A-side service charging identifier is used to correlate session charges for the A-side and a B-side service charging identifier is used to correlate session charges for the B-side, and wherein the A-side charging controller and the B-side charging controller communicate charging information for the session to generate a session charge.
